(19) United States
(12) Patent Application Publication
(10) Pub. No.: US 2026/0288836 A1
(43) Pub. Date: Sep. 24, 2026

(54) SYSTEM

(71) Applicant: SoftBank Group Corp., Tokyo (JP)

(72) Inventor: Kazumasa FUKUDA, Tokyo (JP)

(73) Assignee: SoftBank Group Corp., Tokyo (JP)

(21) Appl. No.: 19/567,363

(22) Filed: Mar. 16, 2026

(30) Foreign Application Priority Data
Mar. 19, 2025 (JP) 2025-045070

(51) Int. Cl. G06F 16/334; G06F 16/2457; G06F 16/34; G06F 16/353

(52) U.S. Cl. CPC G06F 16/3347; G06F 16/24578; G06F 16/345; G06F 16/353

(57) ABSTRACT

A system includes a processor that is configured to use a prompt to instruct a generative AI model to identify important information from dialogues on a communication platform, analyze the identified information using natural language processing techniques and organize and summarize the information based on relevance and importance, and upload the summarized information to a data management platform and set access permissions to make the summarized information available for use across an organization.

### CROSS-REFERENCE TO RELATED APPLICATION

This application is based on and claims priority under 35 USC 119 from Japanese Patent Application No. 2025-045070 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In modern organizations, a large volume of textual communication occurs on communication platforms such as chat tools, collaboration tools, and messaging systems. However, it is difficult for users and organizations to efficiently extract, organize, and reuse important information and knowledge from such dialogues. Conventional techniques generally require manual review of conversation logs or simple keyword search, which do not adequately capture important decisions, issues, or knowledge dispersed across multiple messages and threads. Moreover, even when some information is extracted, it is often not systematically summarized or stored in a data management platform with appropriate access control, resulting in poor organizational knowledge sharing and reuse. In addition, existing approaches typically do not consider users'emotional states when determining the importance of information and the order in which such information should be presented. Furthermore, there is insufficient support for automatically triggering information extraction based on specific events such as mentions in the communication platform, and for automatically instructing a generative AI model to perform appropriate extraction. Therefore, there is a need for a system that can automatically identify important information from dialogues on a communication platform using a generative AI model, that can analyze and summarize the identified information using natural language processing, that can store the summarized information in a data management platform with proper access permissions, and that can further refine the importance and display order of information based on emotion analysis and event-based triggers.

### SUMMARY

In order to solve the above-described problems, an aspect of the invention provides a system comprising a processor, wherein the processor is configured to use a prompt to instruct a generative AI model to identify important information from dialogues on a communication platform. The processor is further configured to analyze the identified information using natural language processing techniques and to organize and summarize the information based on relevance and importance. The processor is also configured to upload the summarized information to a data management platform and to set access permissions so that the summarized information is available for use across an organization. According to another aspect, the processor is configured to evaluate an emotional state from text data using an emotion analysis algorithm in order to analyze a user's emotion, and to evaluate an importance of information based on the evaluated emotional state and adjust a display order of the information in accordance with the evaluated importance. According to still another aspect, the processor is configured to generate a prompt that instructs extraction of information using a specific mention on the communication platform as a trigger, and to transmit the generated prompt to the generative AI model. By these means, the system can automatically and efficiently extract, summarize, and manage important information from communication platform dialogues while taking into account emotional context and event-based triggers, thereby improving knowledge sharing and utilization within the organization.

The term “system” refers to a combination of hardware and software components, including at least one processor and associated memory and interfaces, that operate together to perform the claimed functions.

The term “processor” refers to one or more processing units, such as a central processing unit (CPU), a graphics processing unit (GPU), a microcontroller, or any combination thereof, that execute instructions to perform the claimed operations.

The term “communication platform” refers to any software or service that enables users to exchange messages or conduct dialogues via text, audio, or video, including but not limited to chat tools, collaboration tools, and messaging systems.

The term “dialogues on a communication platform” refers to sequences of messages or interactions exchanged between one or more users via the communication platform, including individual messages, threads, channels, and conversations.

The term “prompt” refers to text or other data provided as input to a generative AI model in order to instruct the model to perform a specific task, such as identifying important information from dialogues.

The term “generative AI model” refers to a machine learning model, such as a large language model or other generative model, that is capable of generating or transforming text or other data in response to a prompt.

The term “important information” refers to information contained in dialogues that is determined to be of particular relevance or significance, such as decisions, issues, tasks, summaries, or key facts, based on predetermined criteria or learned models.

The term “natural language processing techniques” refers to computational methods for analyzing, understanding, or transforming human language, including but not limited to tokenization, parsing, entity recognition, topic detection, and summarization.

The term “relevance” refers to a measure indicating how closely a piece of information is related to a given context, topic, user, or task, as determined by rules, models, or statistical analysis.

The term “importance” refers to a measure indicating the significance or priority of a piece of information relative to other information, which may be determined based on factors such as frequency, user roles, emotional state, or system-defined criteria.

The term “organize and summarize” refers to processing operations that group related pieces of information, structure them into categories or themes, and produce shorter textual representations that capture the essential content of the original information.

The term “summarized information” refers to information that has been processed to reduce length or complexity while preserving essential meaning, context, and key points derived from the original dialogues.

The term “data management platform” refers to a system or service for storing, managing, and providing access to digital data, such as a database, content management system, document repository, or cloud storage service.

The term “access permissions” refers to settings or rules that control which users, roles, or systems are allowed to access, view, modify, or share certain information in the data management platform.

The term “emotion analysis algorithm” refers to software or a model that analyzes text data to estimate the emotional state or sentiment expressed by a user, such as positive, negative, neutral, or more detailed emotional categories.

The term “text data” refers to any data consisting of characters or symbols representing natural language content, including but not limited to messages, posts, comments, transcripts, or logs originating from the communication platform.

The term “emotional state” refers to an estimation of a user's emotion or sentiment, such as happiness, frustration, concern, or neutrality, derived from text data using the emotion analysis algorithm.

The term “display order” refers to the sequence or arrangement in which pieces of information are presented to a user in a user interface, list, dashboard, or other display environment.

The term “specific mention” refers to an explicit reference to a particular user, bot, or system within the communication platform, typically represented by a special syntax such as “@username” or an equivalent mechanism, used as a trigger for system processing.

The term “trigger” refers to an event or condition, such as the occurrence of a specific mention on the communication platform, that initiates or activates a processing operation by the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

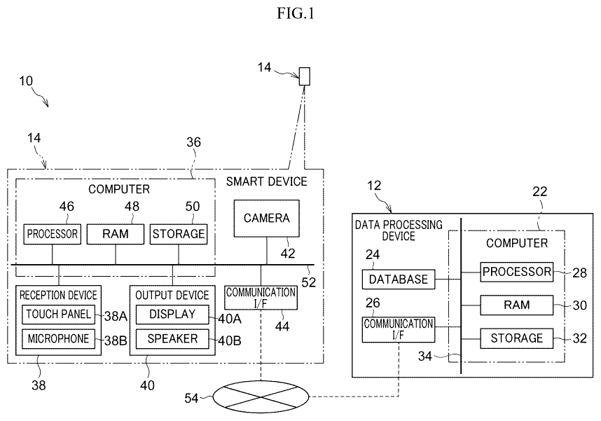

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

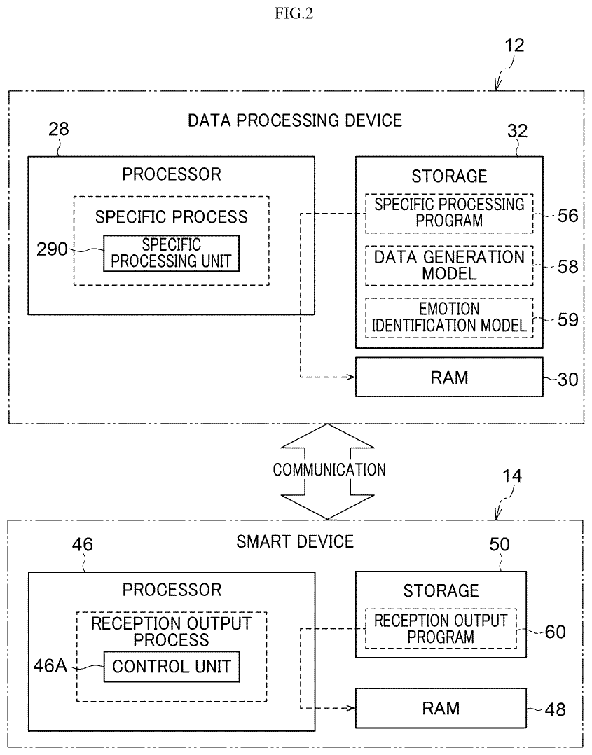

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In large-scale organizations, an increasing volume of dialog data is continuously generated on various information exchange media, such as text-based communication platforms and collaboration environments. Conventional systems typically treat this dialog data as unstructured logs that are archived without effective transformation into reusable organizational knowledge. As a result, critical information such as tasks, decisions, risks, and project status updates is buried in chronological message streams, and users must manually search, read, and interpret long conversations. This manual process is time-consuming, error-prone, and highly dependent on individual skills, which leads to inconsistent knowledge capture and inefficient decision making.

Conventional text analysis tools and business intelligence systems generally operate on pre-defined structured data models and simple keyword or rule-based extraction. These tools are not well-suited to handle nuanced and context-dependent conversational content, and they lack the capability to dynamically adapt extraction criteria to different analysis objectives. Furthermore, known systems that apply machine learning or natural language processing to conversational data often focus on a single function, such as sentiment analysis or topic classification, and do not provide an integrated pipeline that: (i) acquires multi-source dialog data under flexible conditions, (ii) preprocesses and structures the data for robust downstream processing, (iii) leverages a generative AI model with prompt sentences tailored to user-specified goals, (iv) organizes and de-duplicates extracted information into machine-usable structures, and (v) reliably persists and exposes the resulting knowledge through data management media with fine-grained access control.

From the perspective of computer technology, existing approaches also underutilize the computational capabilities of server-side architectures. In many cases, generative models are invoked in an ad hoc manner, with prompts manually crafted on a per-use basis by end users. This causes unstable output quality, redundant computation, and difficulty in scaling across multiple projects and teams. Additionally, conventional systems lack a systematic mechanism to automatically generate prompt sentences based on user-specified analysis conditions, to orchestrate the interaction between preprocessing components, generative models, and summarization modules, and to produce consistent structured representations that can be efficiently stored, indexed, and retrieved by other computer systems.

There is therefore a need for an improved computer-implemented system that technically enhances the way in which dialog data is processed. Specifically, there is a need for a server-controlled pipeline that: (1) automatically acquires dialog data from information exchange media based on specified conditions, (2) performs standardized preprocessing and structuring of the dialog data, (3) programmatically constructs and applies prompt sentences to a generative AI model to extract important information according to different analysis objectives, (4) performs similarity-based integration and categorization of extracted information into well-defined data structures, (5) generates machine-readable and human-readable summaries, and (6) writes such structured and summarized information into data management media with associated management information and access rights. Such a system would improve the functioning of the computer itself by optimizing the interaction between data acquisition, generative AI inference, and knowledge storage, thereby reducing manual intervention, increasing consistency and reusability of extracted knowledge, and enabling scalable, automated knowledge management over large volumes of dialog data.

The specific processing by the specific processing unit 290 of the data processing device 12 in Example 1 is realized by the following means.

The present invention provides a server comprising a processor configured to acquire dialog data from an information exchange medium via an external communication unit based on predetermined conditions, to preprocess the dialog data into preprocessed text data by removing unnecessary symbols and control information and segmenting the dialog data into sentence units or utterance units, to generate input data including the preprocessed text data and a prompt sentence that defines a type of information to be extracted and an output format, to transmit the input data to a generative information processing model and obtain extracted information from the generative information processing model, to analyze and classify the extracted information based on at least an information type, an importance level, and a relevance level and to integrate duplicate or similar information to generate structured information, to generate summarized information in natural language based on the structured information using a summarization algorithm or the generative information processing model, and to write the summarized information and the structured information into a storage unit of a data management medium by uploading the summarized information and the structured information via an external communication unit of the data management medium together with management information including identification information, period information, and user attribute information, and to set an access right defining a utilization range in an organization on the basis of the management information. This enables the computer system to automatically transform large volumes of unstructured dialog data into consistently structured and summarized knowledge objects using a coordinated interaction between preprocessing modules and a generative AI model, to store such knowledge objects in data management media with appropriate access control, and thereby to technically improve the efficiency, scalability, and reliability of dialog-based knowledge extraction and utilization in organizational computing environments.

The term “system” refers to a combination of hardware components and software components that cooperate to execute the processing steps described in the claims.

The term “processor” refers to one or more hardware-based processing units, such as a central processing unit or a graphics processing unit, configured to execute instructions that implement the claimed functions.

The term “dialog data” refers to electronic data representing sequences of messages exchanged between users, including at least text content and optionally metadata such as timestamps, sender identifiers, and channel identifiers.

The term “information exchange medium” refers to a communication environment implemented by computer hardware and software that allows users to exchange dialog data, including, for example, messaging platforms, collaboration tools, or chat services.

The term “storage unit” refers to a hardware-based memory or storage device, such as a non-volatile memory or a database system, configured to store dialog data, structured information, and summarized information.

The term “external communication unit” refers to a hardware interface and associated communication software configured to send and receive data over a communication network using predefined protocols.

The term “predetermined condition” refers to one or more criteria specified in advance, such as a time period, a dialog area, a channel identifier, or a user identifier, used to select dialog data for processing.

The term “character string processing unit” refers to a software-implemented component executed by the processor that performs syntactic operations on text data, including removal of unnecessary symbols and control information and normalization of text.

The term “natural language processing unit” refers to a software-implemented component executed by the processor that analyzes human language text, including segmentation of text into sentence units or utterance units and generation of linguistic structures.

The term “preprocessed text data” refers to dialog data that has been processed to remove unnecessary symbols and control information and has been segmented and structured into units suitable for input to downstream analysis.

The term “input data” refers to a data structure including at least the preprocessed text data and a prompt sentence, which is transmitted to a generative information processing model.

The term “prompt sentence” refers to a textual instruction that specifies at least a type of information to be extracted from the dialog data and an output format to be used by the generative information processing model.

The term “generative information processing model” refers to a machine-learned model, such as a generative AI model, configured to generate output data including extracted information in response to input data including natural language instructions and text.

The term “extracted information” refers to information produced by the generative information processing model, including items identified as important according to the prompt sentence, such as tasks, decisions, risks, or status descriptions.

The term “information type” refers to a classification category assigned to extracted information, such as a task category, a decision category, or a risk category.

The term “importance level” refers to a value or label indicating a relative degree of significance assigned to a piece of extracted information according to predetermined rules or model outputs.

The term “relevance level” refers to a value or label indicating a degree of association between a piece of extracted information and a specified analysis objective, dialog area, or context.

The term “structured information” refers to extracted information that has been organized into a defined data format, such as records or objects with fields for information type, importance level, relevance level, and related attributes.

The term “summarization algorithm” refers to a software-implemented procedure executed by the processor that generates a condensed representation of structured information in natural language.

The term “summarized information” refers to natural language text that concisely represents the content of the structured information in a form more easily understood by human users.

The term “data management medium” refers to a system including at least one storage unit and software components configured to store, manage, and provide access to document data or record data within an organization.

The term “document data” refers to information stored as files or objects that are primarily intended to be read as human-readable documents, including summaries and reports.

The term “record data” refers to structured information stored in a format suitable for machine processing, such as database records or structured entries associated with identifiers.

The term “management information” refers to metadata associated with the summarized information and the structured information, including at least identification information, period information, and user attribute information.

The term “identification information” refers to data that uniquely or distinctively identifies a unit of summarized information or structured information, such as an identifier or a name.

The term “period information” refers to data indicating a time range associated with the dialog data, structured information, or summarized information, such as start and end timestamps or dates.

The term “user attribute information” refers to data representing attributes of users related to the dialog data or information, such as roles, departments, or access levels.

The term “access right” refers to a definition of permissions that specifies which users or groups within an organization are allowed to access, modify, or share particular summarized information or structured information.

The term “utilization range” refers to a scope within an organization, such as specific user groups or organizational units, in which access to the summarized information and structured information is permitted.

The term “terminal device” refers to a user-operated computing device, such as a personal computer, a tablet, or a smartphone, configured to communicate with the server and display information.

The term “response data” refers to data transmitted from the server to the terminal device, including at least the summarized information and the structured information formatted for presentation.

The term “table format” refers to a display format in which information is arranged in rows and columns with labeled fields.

The term “list format” refers to a display format in which information items are presented sequentially as a series of elements, such as bullet points or numbered entries.

The term “indicator display format” refers to a display format in which information is presented as one or more indicators, such as status labels, counts, or graphical markers representing key metrics.

The term “designation conditions” refers to parameters received from the terminal device that specify an analysis target period, a dialog area, and an information extraction purpose.

The term “analysis target period” refers to a time interval indicated by the designation conditions, which defines a subset of dialog data to be analyzed.

The term “dialog area” refers to a scope within the information exchange medium, such as a channel, thread, or conversation group, from which dialog data is to be selected.

The term “information extraction purpose” refers to a specified objective for processing dialog data, such as extraction of project status, tasks, decisions, or risks.

The term “template of the prompt sentence” refers to a predefined text pattern stored in a storage unit, which includes variable portions to be filled with wording corresponding to designation conditions.

The term “automatically generate the prompt sentence” refers to a process executed by the processor to create a prompt sentence by inserting wording related to the designation conditions into the template of the prompt sentence without manual editing by a user.

The term “similarity calculation unit” refers to a software-implemented component executed by the processor that computes a similarity measure between pieces of extracted information based on text features or other attributes.

The term “similarity” refers to a quantitative or qualitative measure that expresses the degree of resemblance between pieces of extracted information.

The term “predetermined threshold” refers to a value specified in advance that is used to determine whether the similarity between two pieces of extracted information is sufficient for them to be integrated into the same group.

The term “same group” refers to a set of pieces of extracted information that have been determined to be sufficiently similar according to the similarity and the predetermined threshold.

The term “integration result” refers to information indicating groupings of extracted information that have been formed based on similarity calculations and threshold comparisons.

The term “category-specific information set” refers to a collection of structured information items belonging to a particular category, such as task information, decision information, or risk information.

The term “task information” refers to structured information describing actions to be performed, including at least a description of the action and optionally related attributes such as responsible persons or due dates.

The term “decision information” refers to structured information describing determinations or choices made in the dialog data, including at least a description of the decision and optionally information about involved parties.

The term “risk information” refers to structured information describing potential problems or uncertain events that may negatively affect a project or activity, including at least a description of the risk and optionally an impact or likelihood.

In one embodiment, a server implements the claimed system as a network-accessible computing node deployed, for example, on a virtual machine in a data center. The server includes at least one central processing unit (CPU), a main memory, a non-volatile storage device, and a network interface. The server executes an operating system such as a general-purpose server operating system and application software implemented, for example, using a programming language runtime. The server communicates with at least one terminal operated by a user and with at least one information exchange medium and at least one data management medium via a wired or wireless communication network.

The server stores a program that, when executed by the processor, causes the server to function as a plurality of logical modules, including an acquisition module, a preprocessing module, a prompt generation module, a generative AI interaction module, an information structuring module, a summarization module, a similarity calculation module, and a data management interface module. These modules process dialog data, generate prompt sentences, interact with a generative AI model, convert unstructured dialog streams into structured and summarized information, and persist the resulting information in data management media with associated management information and access rights.

The terminal is implemented as a client device such as a personal computer, a tablet, or a smartphone. The terminal executes a web browser or a dedicated application and presents a user interface that allows the user to specify designation conditions, to request analysis of dialog data, and to display structured information and summarized information transmitted from the server. The terminal sends the designation conditions to the server using a secure network protocol and receives response data including display-ready representations such as tables, lists, and indicators.

The user operates the terminal to authenticate against the server and to specify an analysis target period, a dialog area, and an information extraction purpose. The user selects, for example, a communication channel, a time range, and an analysis objective such as extraction of project status, extraction of decisions, or extraction of tasks and risks. The user then initiates processing by issuing a request from the terminal to the server.

The server communicates with the information exchange medium, which is implemented as a software-based communication environment including message storage and an application programming interface (API). The information exchange medium stores dialog data representing sequences of messages exchanged between multiple users, together with metadata such as timestamps, sender identifiers, and conversation identifiers. The server uses the external communication unit to access the API of the information exchange medium and to retrieve dialog data that satisfies predetermined conditions, such as a specified time interval and one or more specified conversation identifiers.

The server uses a preprocessing module to normalize the retrieved dialog data into preprocessed text data. The server removes unnecessary symbols and control information, such as markup tags, formatting codes, and automatically generated system notifications. The server applies tokenization, sentence boundary detection, and utterance segmentation using a natural language processing library. The server converts heterogeneous raw message formats into a standardized internal data structure that stores, for each utterance, at least a text field, a speaker identifier, a timestamp, and a conversation context identifier. This normalization enables the subsequent generative AI processing to be applied consistently, regardless of the original format of the information exchange medium.

The server uses a prompt generation module to construct a prompt sentence that defines a type of information to be extracted and an output format. The server maintains a set of prompt templates, each associated with a particular information extraction purpose, in the storage unit. When the server receives the designation conditions from the terminal, the server selects a template corresponding to the information extraction purpose and inserts wording that reflects the analysis target period and the dialog area. This automatic generation of a prompt sentence reduces variability and human error compared to manual prompt design and enforces a consistent structure for input to the generative AI model.

For example, when the user selects an information extraction purpose corresponding to project progress, the server can generate a prompt sentence as follows:
“From the following conversation, extract the current project status, completed tasks, ongoing tasks, blocked tasks, and risks. Return the result as a structured description suitable for further machine processing and human review.”

As another example, when the user selects an information extraction purpose corresponding to decision extraction, the server can generate a prompt sentence as follows:
“Identify all decisions made in the following conversation. For each decision, provide a short description, the date if mentioned, and the people involved. Return the result as a clearly separated list of decision items.”

The server combines the preprocessed text data and the generated prompt sentence into input data for a generative AI model. In one embodiment, the server uses a generative AI model implemented as a large-scale neural network with a transformer architecture. The model includes an embedding layer that converts tokenized input text into numerical vectors, a plurality of self-attention layers that compute contextualized representations of each token using attention weights, and a final decoding layer that generates output tokens. The generative AI model has been trained in advance using a large corpus of text data, employing a training objective such as next-token prediction. During training, the model parameters (weights and biases) have been updated by an optimization algorithm such as stochastic gradient descent with adaptive moment estimation. The loss function used during training may include a cross-entropy component that measures divergence between predicted token distributions and ground-truth tokens.

The server encodes the prompt sentence and the preprocessed text data into the token sequence required by the generative AI model, sets inference parameters such as maximum output length and a sampling strategy, and transmits the encoded input to the model via a generative AI API. In one embodiment, the generative AI interaction module executes on the server and calls a remote model hosting service via a network; in another embodiment, a locally hosted model runs on specialized hardware such as a graphical processing unit or a tensor processing unit connected to the server.

The server receives output from the generative AI model as a sequence of tokens, decodes the tokens into natural language text, and parses the text according to the output format specified in the prompt sentence. In some embodiments, the prompt sentence instructs the model to output information separated by markers or headings corresponding to information types, such as “Project Status,” “Completed Tasks,” “Ongoing Tasks,” “Blocked Tasks,” and “Risks.” By constraining the output structure using such markers and by standardizing prompt templates, the server reduces parsing complexity and increases the stability of downstream processing compared to unconstrained text generation.

The server converts the parsed output into structured information. The structured information may be represented as records, each record including fields for an information type, an importance level, a relevance level, and associated attributes such as references to specific utterances in the original dialog data. The server can compute importance levels by combining signals such as the position of the item in the model output, presence of specific keywords, and user-specified priorities. The server can compute relevance levels by measuring, for example, the similarity between the item description and a representation of the information extraction purpose.

The server uses a similarity calculation module to identify duplicate or similar pieces of extracted information. The similarity calculation module transforms text snippets associated with each extracted item into numerical feature vectors. These feature vectors may be generated using word embeddings or sentence embeddings derived from a neural network encoder. The server computes similarity metrics such as cosine similarity between feature vectors. If the similarity between two items exceeds a predetermined threshold, the server integrates the items into the same group. This grouping mitigates redundancy that frequently arises in dialog data, in which multiple utterances may refer to the same task or decision using different wording.

The server generates category-specific information sets by assigning each group of items to one or more categories, such as task information, decision information, and risk information.

The server can use rule-based classification (for example, presence of “decide,” “approved,” or similar expressions) or learned classifiers trained on labeled examples of dialog segments. Categorizing the structured information enables more efficient indexing and retrieval in the data management medium and supports finer-grained display options on the terminal.

The server generates summarized information in natural language based on the structured information. In one embodiment, the server uses a summarization algorithm that selects representative items according to importance levels and relevance levels, orders them according to timestamps or categories, and applies template-based text generation to produce coherent narrative text. In another embodiment, the server uses the generative AI model in a summarization mode, providing the structured information as input and instructing the model, via a summarization-specific prompt sentence, to produce a summary of specified maximum length. For example, the server can use a prompt sentence such as:
“Based on the following structured information about a project extracted from internal chat, summarize the overall project status in clear and concise language, in no more than 200 words.”

The server stores both the structured information and the summarized information in a storage unit and transmits them to a data management medium. The server uses the external communication unit of the data management medium to upload document data and record data, together with management information that includes identification information, period information, and user attribute information. The server sets access rights on the data management medium so that only authorized users or groups within an organization can access, modify, or share the stored information. The server records identifiers or uniform resource locators associated with the stored information and returns them to the terminal in response data.

The terminal displays the summarized information and the structured information in formats appropriate to the categories and the designated analysis purpose. For example, the terminal can present tasks in a table format with columns such as description, responsible person, and due date; decisions in a list format; and risks in an indicator format that highlights severity or likelihood. The terminal can also provide interactive controls that allow the user to filter, sort, or expand items and to navigate back to the original utterances in the dialog data. By using structured information rather than raw logs, the terminal can generate more responsive and informative user interfaces with reduced client-side processing load.

From a technical standpoint, the described system improves the functioning of the server and networked computer environment in several ways. The server standardizes inputs to the generative AI model using predetermined prompt templates and normalized preprocessed text data, which leads to more predictable and parseable outputs. This reduces the need for repeated trial-and-error interactions that would otherwise consume network bandwidth and processing time. The use of a similarity calculation module with embedding-based representations allows the server to identify and merge semantically related items that would be difficult to detect using simple keyword matching, thereby reducing redundancy in stored data and improving the efficiency of search and retrieval operations in the data management medium.

The server's pipeline, which integrates acquisition, preprocessing, prompt generation, generative inference, structuring, similarity-based integration, summarization, and storage, is designed to minimize unnecessary data transfers and repeated computations. For example, the server reuses preprocessed text data and intermediate representations across multiple extraction purposes within the same analysis target period, and the server caches intermediate embedding vectors to avoid recomputation in similarity calculations. These design choices reduce latency and computing resource usage when repeatedly analyzing overlapping dialog regions for different objectives.

The generative AI model is not used merely as a black-box replacement for human reading; instead, the server constrains and orchestrates the model's operation through specifically engineered prompt sentences, structural markers, and post-processing algorithms. The server's similarity-based integration and category-specific grouping represent non-conventional post-processing of generative outputs, which is different from traditional rule-based text analytics. The model's learned contextual representations, derived from its transformer architecture and pretraining, are exploited in combination with these non-conventional rules to achieve higher precision and recall in identifying tasks, decisions, and risks in dialog data compared to keyword-only or rule-only systems.

By converting unstructured dialog data into normalized preprocessed text data, by supplying that data to a generative AI model under standardized prompt constraints, by converting the resulting outputs into structured information and category-specific information sets, and by storing that information in data management media with associated management information and access rights, the server achieves a technical improvement in data management. The system reduces storage redundancy by grouping similar items, enhances indexing efficiency by using well-defined categories and identifiers, and improves retrieval performance by allowing queries to operate on structured fields rather than on full-text logs. These improvements enable more efficient utilization of storage and computational resources across the networked environment.

In alternative embodiments, the server may adjust the configuration of the generative AI model, such as the number of transformer layers, the dimensionality of embeddings, and inference parameters, to balance processing speed and quality of extracted information according to system constraints. The server may also support different similarity metrics, such as Euclidean distance or learned similarity functions, and may employ clustering algorithms to form groups of related items beyond pairwise thresholding. Furthermore, the server may implement incremental learning strategies in which new examples of correctly extracted tasks, decisions, or risks are used to fine-tune classifier components or summarization modules, thereby continuously improving accuracy over time without retraining the entire model.

In another embodiment, multiple servers operate in a distributed arrangement, where one server specializes in acquiring and preprocessing dialog data from the information exchange medium, another server hosts the generative AI model, and another server manages structured information and summarized information in the data management medium. The servers exchange intermediate results using specified data structures and communication protocols, which further increases scalability and throughput for large organizations with numerous simultaneous analysis requests.

In all of these embodiments, the server, the terminal, and the user cooperate through precisely defined data structures, algorithms, and generative AI interactions that are specifically engineered to leverage the capabilities of the underlying computer hardware and software. The system does not merely automate human reading and summarization but instead introduces a technical arrangement in which transformer-based generative models, similarity-based grouping, template-driven prompt generation, and structured storage together produce a concrete improvement in how computers process, manage, and utilize large volumes of dialog data.

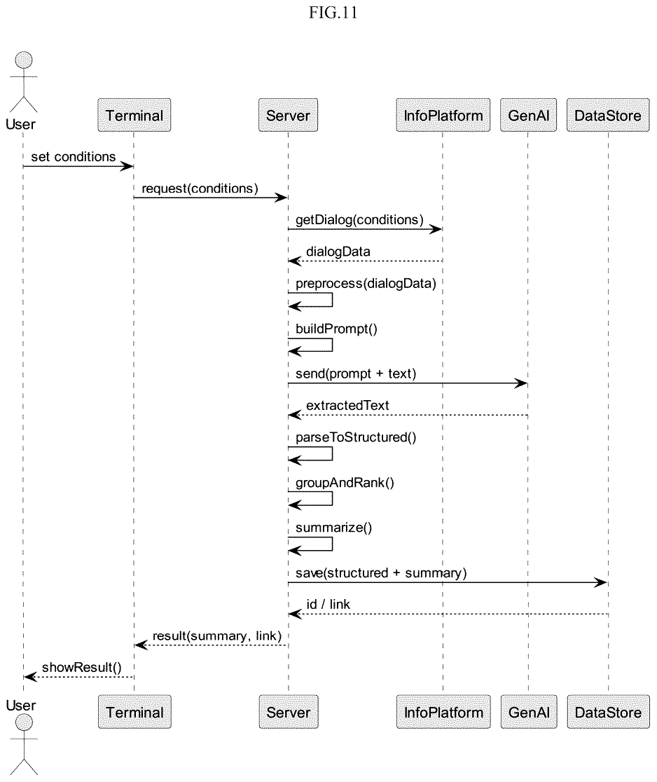

The following describes the processing flow using FIG. 11.

### Step 1:

The user operates the terminal to specify designation conditions for analysis.

The input to this step is user interaction, including selection of an analysis target period, a dialog area, and an information extraction purpose through a graphical user interface.

The terminal converts the user's selections into a structured request message that includes, for example, a time range, one or more conversation identifiers, a selected analysis type (such as project progress, decisions, or risks), and user authentication information.

The terminal transmits this request to the server over a network using a secure protocol.

The output of this step is a request payload containing the designation conditions, sent from the terminal to the server.

### Step 2:

The server receives the request payload from the terminal and validates the designation conditions.
The input to this step is the structured request message including the time range, dialog area identifiers, analysis type, and user authentication information.
The server parses the request, verifies that the user is authorized to access the specified dialog area, and checks that the time range and analysis type are syntactically valid.
The server generates an internal job descriptor that includes normalized representations of the designation conditions, such as standardized timestamps and internal identifiers for the dialog area and the analysis purpose.
The output of this step is a validated and normalized job descriptor stored in the server's memory.

### Step 3:

The server acquires dialog data from the information exchange medium based on the job descriptor.
The input to this step is the job descriptor containing the target period and dialog area identifiers.
The server uses its external communication unit to call an API of the information exchange medium, constructing API requests that include the conversation identifiers and time boundaries.
The server receives one or more API responses containing raw dialog data, typically as message objects with fields such as message text, timestamp, sender identifier, and thread identifier.
The server aggregates the responses, resolves pagination if necessary, and stores the raw dialog data in a temporary storage area or a database.
The output of this step is a collection of raw dialog records associated with the job descriptor.

### Step 4:

The server preprocesses the raw dialog data to generate preprocessed text data.
The input to this step is the collection of raw dialog records retrieved from the information exchange medium.
The server applies character string processing to each record, removing control characters, markup tags, emoji codes, and automatically generated system messages that do not contribute to semantic content.
The server uses a natural language processing unit to segment the remaining text into sentence units or utterance units, performs tokenization, and normalizes whitespace and encoding.
The server constructs an internal data structure for each utterance that includes a cleaned text field, a speaker identifier, a normalized timestamp, and a conversation context identifier.
The output of this step is preprocessed text data in a structured form suitable for further analysis.

### Step 5:

The server constructs a prompt sentence corresponding to the information extraction purpose.
The input to this step is the job descriptor, which specifies the analysis target period, dialog area, and information extraction purpose.
The server selects a prompt template from a storage unit based on the information extraction purpose and inserts dynamic wording that reflects the target period and dialog area into placeholder positions in the template.
The server may also insert additional constraints into the prompt sentence, such as a required output structure or length limits, to standardize the generative AI model output.
The server generates a finalized prompt sentence, for example:
“From the following conversation, extract the current project status, completed tasks, ongoing tasks, blocked tasks, and risks. Return the result as a structured description suitable for further machine processing and human review.”
The output of this step is a completed prompt sentence associated with the job descriptor.

### Step 6:

The server generates input data for a generative AI model by combining the preprocessed text data with the prompt sentence.
The input to this step is the preprocessed text data from Step 4 and the prompt sentence from Step 5.
The server concatenates the prompt sentence and selected segments of the preprocessed text data into a single textual input sequence, optionally inserting markers such as “Prompt:” and “Conversation:” to clarify boundaries.
The server encodes the combined text into the tokenization format required by the generative AI model, such as subword tokens, and constructs a model input object that includes the token sequence and inference parameters such as maximum output length and decoding strategy.
The output of this step is a model input object ready to be transmitted to the generative AI model.

### Step 7:

The server transmits the model input object to the generative AI model and obtains extracted information.
The input to this step is the model input object containing the tokenized prompt sentence and preprocessed text data.
The server calls a generative AI API or a locally hosted generative AI model, sending the model input object via a network or an inter-process communication mechanism.
The generative AI model internally performs embedding, multi-head self-attention, and feedforward computations across multiple layers to generate contextualized token representations and then decodes an output token sequence according to the prompt constraints.
The server receives the output token sequence, decodes the tokens into natural language text, and associates the resulting text with the corresponding job descriptor.
The output of this step is raw generative output text that contains candidate extracted information as directed by the prompt sentence.

### Step 8:

The server parses the raw generative output text into structured extracted information.
The input to this step is the generative output text from Step 7.
The server analyzes the output, using predefined delimiters, headings, or patterns specified in the prompt, to separate different items and fields such as project status, tasks, decisions, or risks.
The server converts each identified item into a record with fields for an information type, a description, and optional attributes such as responsible user or due date.
The server stores the parsed records in an internal data structure, linking them back to the job descriptor and, if applicable, to the original utterances in the dialog data.
The output of this step is a set of extracted information records in a machine-readable structured format.

### Step 9:

The server calculates similarity between pieces of extracted information and groups similar items.
The input to this step is the set of extracted information records from Step 8.
The server generates vector representations for the text of each record, for example by using an embedding model or encoder that maps text to numerical vectors in a high-dimensional space.
The server computes similarity metrics, such as cosine similarity, between pairs or clusters of vectors, and compares each similarity value against a predetermined threshold.
The server integrates records whose similarity exceeds the threshold into common groups, merging redundant descriptions and aggregating related attributes into single composite records.
The output of this step is grouped and de-duplicated structured information, with each group representing a unique underlying task, decision, or risk.

### Step 10:

The server assigns categories and importance or relevance levels to the grouped structured information.
The input to this step is the grouped structured information from Step 9 and, optionally, the job descriptor.
The server uses rule-based classifiers or learned classifiers to assign each group to one or more categories, such as task information, decision information, or risk information, based on lexical cues, context, and extraction purpose.
The server calculates importance levels using criteria such as frequency of mentions, timestamps, and emphasis indicators in the original dialog, and calculates relevance levels based on similarity between item descriptions and a representation of the analysis purpose.
The server augments each record with category labels, importance levels, and relevance levels, producing enriched structured information.
The output of this step is categorized structured information with associated importance and relevance metadata.

### Step 11:

The server generates summarized information in natural language from the categorized structured information.
The input to this step is the categorized structured information from Step 10.
The server selects representative items according to importance and relevance thresholds, orders them according to logical criteria such as chronology or category grouping, and applies a summarization algorithm that transforms the selected items into coherent text.
In some configurations, the server creates an additional prompt sentence for summarization, such as:
“Based on the following structured information extracted from internal chat, summarize the overall project status in clear and concise language in no more than 200 words.”
The server optionally calls the generative AI model again with this summarization prompt and the structured information to generate refined summary text.
The output of this step is one or more segments of summarized information in natural language associated with the job descriptor.

### Step 12:

The server writes the structured information and summarized information into a data management medium with associated management information.
The input to this step is the categorized structured information and the summarized information from Steps 10 and 11, together with system-generated identifiers and user-related attributes.
The server constructs document data for human-readable summaries and record data for machine-readable structured information, and attaches management information including identification information, period information, and user attribute information.
The server uses an external communication unit to upload these data objects to the data management medium via its API, and sets access rights that specify which organizational entities can read or modify the stored information.
The server records the storage locations or identifiers returned by the data management medium in association with the job descriptor.
The output of this step is persistent storage of the structured information and summarized information in the data management medium, with defined access rights and identifiers.

### Step 13:

The server generates response data for the terminal and transmits the analysis results.
The input to this step is the stored structured information and summarized information, along with their identifiers and metadata from the data management medium.
The server formats the data into one or more response payloads optimized for display, including tables for tasks, lists for decisions, and indicator structures for risks or status.
The server embeds links or identifiers that allow the terminal or the user to access the corresponding entries in the data management medium.
The server transmits the response payloads to the terminal over the network, associated with the original request context.
The output of this step is response data delivered to the terminal, containing the analysis results and references to stored knowledge.

### Step 14:

The terminal receives the response data and presents the analysis results to the user.
The input to this step is the response payload sent from the server in Step 13.
The terminal parses the payload and renders the structured information and summarized information in the user interface, using list views, table views, and graphical indicators according to category and importance.
The terminal provides interactive elements that enable the user to expand details of individual items, filter or sort records, and follow links to the full entries stored in the data management medium.
The terminal thus outputs a visual representation on a display device, allowing the user to inspect and further utilize the extracted and summarized knowledge.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In large-scale communication environments, such as enterprise messaging platforms and collaborative tools, users generate substantial volumes of unstructured conversation data. Conventional systems typically treat such conversation data as transient text streams and rely on simple keyword search, static rule-based filters, or manual curation to surface relevant information. As a result, these systems suffer from several technical drawbacks.

First, existing architectures do not efficiently transform raw conversation data into structured, machine-usable representations that can drive downstream retrieval and recommendation processes. Natural language inputs are often processed only superficially, leading to incomplete or noisy extraction of topics and an inability to accurately infer user interests over time. This results in low-quality recommendations and poor utilization of underlying storage systems and network resources.

Second, typical solutions do not tightly integrate generative artificial intelligence models into the processing pipeline in a manner that systematically converts conversational context into optimized, machine-readable prompt sentences and search queries. Generative models, where used, are often employed as standalone assistants, without coordinated orchestration with natural language preprocessing modules, information storage systems, and access control mechanisms. Consequently, the computational capabilities of generative models are underutilized, and the system cannot automatically derive high-quality search queries or recommendation prompts tailored to ongoing conversations.

Third, conventional systems are not architected to dynamically adjust recommendation behavior based on real-time emotional analysis and inferred user interest levels. Emotion analysis, when present, is typically decoupled from ranking logic and does not alter the way content is prioritized for display on user terminals. This leads to inefficient ranking strategies, higher cognitive load on users, and increased processing overhead due to users repeatedly issuing ad hoc queries or manual filtering operations.

Fourth, prior systems lack a robust trigger mechanism within communication platforms for initiating a coordinated sequence of information extraction, keyword extraction, generative-model prompting, and recommendation processing. As a result, the system either processes every message indiscriminately, wasting processing resources and network bandwidth, or requires manual intervention to start analysis, which impedes real-time responsiveness.

Overall, these limitations result in technical inefficiencies at multiple layers of the computing environment, including suboptimal utilization of processing resources for natural language analysis, inefficient use of storage and indexing systems due to low-quality queries, and increased latency and bandwidth usage caused by repeated, non-optimized retrieval operations. There is a need for an improved computer-implemented system that: (i) systematically converts unstructured conversation data into structured representations; (ii) leverages generative AI models through precisely constructed prompt sentences and search queries; (iii) integrates emotion analysis and inferred interest into ranking and presentation logic; and (iv) employs event-based triggers within the communication platform to initiate an orchestrated processing pipeline. Such a system would improve the functioning of the underlying computer technology for managing, retrieving, and presenting information derived from conversational data.

The specific processing by the specific processing unit 290 of the data processing device 12 in Application Example 1 is realized by the following means.

The present invention provides a server comprising a processor and a memory storing instructions that, when executed by the processor, cause the server to acquire conversation data generated on a communication platform from a user terminal as structured data; to preprocess the conversation data using a natural language processing program, including segmentation, normalization, and removal of unnecessary information, to extract one or more keywords from the preprocessed conversation data; to generate, from input information including the extracted keyword and at least a part of the conversation data, a prompt sentence configured to instruct a generative language model to identify information related to the keyword; to transmit the prompt sentence to the generative language model and to obtain, from the generative language model, a search query sentence or a recommendation prompt sentence generated on the basis of the keyword and the conversation data; to execute a search request to an information storage system or an external information providing system by using the obtained search query sentence or recommendation prompt sentence and acquire related content; to analyze the information extracted from the conversation data and the acquired related content by using the natural language processing program and the generative language model, and to organize and summarize the information on the basis of relevance and importance to generate knowledge information; to associate the generated knowledge information and the related content with access control information to generate management data and upload the management data to a data management system so that the knowledge information and the related content are shareable within an organization; and to structure the related content and the knowledge information as recommendation information suitable for display on the user terminal and transmit the recommendation information to the user terminal. This enables the computing system to more efficiently transform unstructured conversational text into structured, high-quality search queries and recommendations, to improve the relevance and prioritization of content presentation based on real-time conversational context and user state, and to reduce processing overhead, storage inefficiencies, and network traffic associated with conventional ad hoc retrieval and manual curation of information derived from communication platforms.

The term “system” refers to a combination of one or more hardware components and one or more software components that cooperatively perform specified processing, including at least a processor and associated memory, and optionally including one or more user terminals, storage devices, and communication interfaces.

The term “processor” refers to one or more hardware computation units, such as a central processing unit or a processing core, capable of executing machine-readable instructions to perform logical, arithmetic, and control operations.

The term “memory” refers to one or more hardware storage units, such as volatile memory or non-volatile memory, configured to store instructions and data used by the processor during execution.

The term “user terminal” refers to an information processing device operated by a user, such as a computing device or a communication device, capable of transmitting conversation data to a server and receiving recommendation information for display.

The term “communication platform” refers to a software-based communication environment or service that enables exchange of text messages or other interaction data among multiple users or devices over a network.

The term “conversation data” refers to electronic text data or message content generated through user interactions on a communication platform, including individual messages, sequences of messages, and associated metadata.

The term “structured data” refers to data that has been converted into a defined format according to a predetermined schema, such as key-value pairs or a data record, enabling systematic processing by a computer program.

The term “natural language processing program” refers to a software module or library configured to analyze text written in a natural language, including functions such as tokenization, segmentation, normalization, part-of-speech tagging, and extraction of linguistic features.

The term “segmentation” refers to a processing operation that divides text into smaller units, such as sentences, clauses, or tokens, based on syntactic or statistical rules.

The term “normalization” refers to a text processing operation that converts multiple variants of expressions into a standardized form, including operations such as lowercasing, canonicalization of characters, and unification of similar expressions.

The term “removal of unnecessary information” refers to a text filtering operation that eliminates elements that are not relevant to subsequent analysis, such as stop words, markup, control characters, or specific non-informative tokens.

The term “keyword” refers to a term or short phrase extracted from conversation data that is determined to be relevant to the topic, intent, or interest represented in the conversation.

The term “input information” refers to a set of data elements provided as input to a processing step, including at least one keyword and at least a part of the conversation data.

The term “prompt sentence” refers to a natural language expression or instruction provided as input to a generative language model, configured to cause the model to perform a specific generation task, such as identifying relevant information or producing a search query.

The term “generative language model” refers to a software-implemented statistical or neural network model trained on language data and configured to generate natural language text or structured outputs in response to an input prompt.

The term “search query sentence” refers to a text string or natural language expression generated for the purpose of querying an information storage system or an external information providing system to retrieve related content.

The term “recommendation prompt sentence” refers to a text string or natural language expression generated for the purpose of requesting that a generative language model or another system produce recommended content or related items.

The term “information storage system” refers to a system including one or more storage devices and associated software configured to store, index, and retrieve information items such as documents, records, or media objects.

The term “external information providing system” refers to a computing system or service that is distinct from the server and that supplies information or content, such as documents, articles, or multimedia data, in response to a query.

The term “related content” refers to one or more information items, such as documents, records, or media objects, returned by an information storage system or an external information providing system in response to a search query sentence or recommendation prompt sentence.

The term “analyze” refers to the processing of data using one or more algorithms or software modules to derive structure, relationships, or attributes from the data, including but not limited to linguistic analysis, semantic analysis, and relevance scoring.

The term “relevance” refers to a degree or measure indicating how closely a piece of information or related content matches a topic, keyword, user interest, or conversational context.

The term “importance” refers to a degree or measure representing a priority level assigned to information or related content based on one or more factors, including relevance, inferred user interest, and emotional state.

The term “knowledge information” refers to structured or summarized information derived from conversation data and related content, representing distilled insights, conclusions, or key points suitable for reuse and sharing.

The term “access control information” refers to data describing constraints or permissions regarding which entities or users are allowed to access or manipulate specific pieces of knowledge information or related content.

The term “management data” refers to data records that combine knowledge information, related content, and access control information, and are used to manage storage, retrieval, and sharing of such information in a system.

The term “data management system” refers to a computer-implemented system configured to store, organize, index, and provide controlled access to management data, including functions for searching, updating, and sharing information within an organization.

The term “shareable within an organization” refers to a state in which knowledge information and related content are accessible to authorized users belonging to an organizational unit through the data management system.

The term “recommendation information” refers to structured data describing one or more related content items and associated knowledge information, prepared in a form suitable for presentation to a user as recommended items.

The term “display on the user terminal” refers to the visual presentation of recommendation information or other content via a user interface on a user terminal, such as on a display screen.

The term “emotion analysis algorithm” refers to a software-implemented procedure configured to estimate an emotional state from text data, based on features such as word choice, syntax, or statistical patterns.

The term “emotional state” refers to a representation of an inferred emotion or affective condition associated with a user or a piece of text, such as positive, negative, neutral, or more fine-grained emotional categories.

The term “user interest level” refers to a quantitative or qualitative value that represents a degree of interest of a user in a particular topic or content, estimated based on conversation data and processing by a generative language model or other algorithms.

The term “importance level” refers to a value computed for the purpose of ranking or prioritizing content, derived from factors such as emotional state and user interest level.

The term “display order” refers to an arrangement or sequence in which multiple pieces of recommendation information or content items are presented on a user terminal.

The term “recommendation priority” refers to a parameter or rank used by a system to determine which content items should be recommended first or emphasized more strongly to a user.

The term “predetermined symbol” refers to a character or group of characters, defined in advance by system configuration, that can act as a trigger when detected in conversation data.

The term “predetermined phrase” refers to a specific sequence of words, defined in advance by system configuration, used as a trigger condition when present in conversation data.

The term “predetermined action” refers to a predefined operation or event within a communication platform, such as a mention, reaction, or command invocation, that the system recognizes as a trigger.

The term “trigger” refers to a condition or event that, when detected, causes initiation of one or more processing steps, such as prompt generation, information extraction, or recommendation processing.

The term “information extraction” refers to a process that identifies and retrieves specific pieces of information, such as entities, relationships, or facts, from unstructured or semi-structured text.

The term “keyword extraction” refers to a process that identifies words or phrases from text that are representative of the main topics or subjects discussed.

The term “query generation” refers to a process that produces a search query sentence or other query structure from input data such as keywords and conversation context.

The term “related content recommendation” refers to a process of selecting and presenting content items that are determined to be relevant to a user's conversation, interests, or context, based on analysis and scoring.

In one embodiment, a server cooperates with one or more terminals and one or more storage systems to implement the claimed system. The server includes at least one processor, a main memory, a non-volatile storage device, and a network interface. The processor is, for example, a general-purpose central processing unit or a multi-core processor installed in a rack-mounted or virtualized server. The memory stores an operating system, a web application framework, a natural language processing program, a generative AI model client, and application logic that realizes the claimed functions. The non-volatile storage device stores conversation logs, extracted keywords, generated prompt sentences, search query sentences, recommendation prompt sentences, related content metadata, knowledge information, access control information, and management data.

The terminal is, for example, a smartphone, a tablet, or a personal computer operating a communication platform client. The terminal executes communication software such as an enterprise messaging client or a web browser, displays a user interface for sending and receiving messages, and communicates with the server over a packet-switched network. The user inputs text messages, reacts to messages, and selects recommended content on the terminal.

The server uses a natural language processing program such as a spaCy-based or NLTK-based module running on the processor to analyze conversation data. The server optionally deploys a search engine such as a full-text indexer on a separate storage system to store documents and provide relevance scoring. The server accesses one or more external information providing systems via web APIs. The server uses a generative AI model, for example a transformer-based neural language model accessible through an API, as a component in the processing pipeline. The generative AI model is an encoder-decoder or decoder-only architecture with multiple self-attention layers, feed-forward layers, and learned token embeddings. The model parameters are trained in advance on large-scale text corpora by minimizing a cross-entropy loss between predicted tokens and target tokens, using gradient-based optimization such as stochastic gradient descent or adaptive gradient algorithms. The server does not retrain the generative AI model in ordinary operation but uses its inference function as a deterministic mapping from prompt sentences to generated text under fixed parameters.

The server defines an internal data structure for conversation data. The server stores each user message as a record including a user identifier, a channel identifier, a timestamp, a raw text string, and additional metadata such as message type and reaction information. The server stores the record in a relational database or a key-value store. The server associates conversation records with a conversation session identifier that permits efficient retrieval of a subset of messages related to a particular user, topic, or time interval. The server uses indexed columns or secondary indexes to reduce retrieval time.

The server uses the natural language processing program to tokenize the raw text of conversation data into individual tokens and to assign part-of-speech tags and syntactic dependencies to each token. The server uses a segmentation operation to split long text into sentences. The server performs normalization, such as converting characters into canonical forms, unifying diacritical variants, and mapping different encodings to a standard representation. The server removes unnecessary information, such as URLs, markup sequences, and non-informative system messages, by applying regular-expression filters and stop-word lists tuned for the particular communication platform. This processing transforms arbitrary-length raw text into a normalized token sequence with associated linguistic features, which improves the performance of subsequent keyword extraction and reduces the number of irrelevant tokens processed by the generative AI model, thereby improving computational efficiency and memory utilization.

The server uses rule-based and statistical methods to extract keywords from the tokenized conversation data. The server selects tokens whose part-of-speech tags indicate nouns, proper nouns, and domain-relevant verbs, and excludes tokens that appear in a configurable stop-word lexicon. The server optionally computing term frequency or term frequency-inverse document frequency scores over a sliding time window. The server selects a small set of tokens and token n-grams with the highest scores as candidate keywords. This keyword extraction step reduces the dimensionality of the conversational context to a compact representation while preserving the main topics. By restricting subsequent generative AI model calls to these keywords and a short conversation excerpt, the server decreases the size of the input token sequence to the generative AI model, which reduces inference latency and network bandwidth when communicating with the model service.

The server constructs prompt sentences by combining extracted keywords with conversation excerpts in human-readable natural language templates. The server encodes system-level instructions in the prompt sentences to cause the generative AI model to generate search query sentences and recommendation prompt sentences in a controlled format. For example, the server generates prompt sentences such as:
“Based on the following user conversation and keywords, infer the user's interests and generate three concise search queries for relevant technical articles. Conversation: ‘I've been really interested in the recent evolution of technology, especially AI and robotics.’ Keywords: ‘technology evolution’, ‘AI’, ‘robotics’.”
“Summarize the user's interests from the following dialogue and produce two natural-language search queries to retrieve tutorial videos. Conversation: ‘That article about AI-driven robotics was very helpful. I'd like to learn more about applications in healthcare.’ Keywords: ‘AI-driven robotics’, ‘healthcare applications’.”
“From this dialogue, identify the top three topics the user is interested in and output one search query sentence for each topic. Conversation: ‘I want to understand recent progress in cloud computing and edge computing.’Keywords: ‘cloud computing’, ‘edge computing’.”

The server also uses prompt sentences to obtain summaries and knowledge information, for example:
“Summarize the key insights about the evolution of AI and robotics discussed in the following user conversation in 4 bullet points, focusing on technical trends and challenges.”
“Create a short summary suitable for an internal knowledge base that explains recent AI technology evolution based on the following notes.”

The server processes prompt sentences using a generative AI model interface module. The server converts each prompt sentence into a sequence of model tokens using a tokenizer consistent with the generative AI model's vocabulary. The server includes meta-tokens indicating roles such as system instructions and user input. The generative AI model internally applies multiple layers of self-attention and feed-forward transformations to compute the logits of next tokens. The generative AI model selects successive tokens according to a selection rule such as top-k sampling or nucleus sampling under a preset temperature parameter, until an end-of-sequence token appears or a maximum token length is reached. The server receives the generated tokens and decodes them into a text string that constitutes a search query sentence or a recommendation prompt sentence.

The server uses the search query sentence to query an information storage system, such as a search engine index containing news articles, documentation, or media metadata. The server converts the natural language query into the query language of the index, for example by mapping keywords into query clauses and applying field-specific boosts. The server submits the query to the storage system and receives ranked results, each result including at least an identifier, a title, a summary snippet, and a relevance score. The server optionally uses similarity computations, such as cosine similarity over embedded representations, to re-rank or filter results.

The server uses the recommendation prompt sentence to either query additional systems or to further invoke the generative AI model to generate abstractive summaries or topic labels. In one embodiment, the server sends the recommendation prompt sentence back to the generative AI model along with metadata of top-ranked search results, instructing the model to propose a curated subset of content tailored to the inferred user interests and expertise level.

The server generates knowledge information by combining extracted information from conversation data and related content using both the natural language processing program and the generative AI model. The server extracts entities, technical concepts, and relationships from the conversation and related content, and assembles them into a structured representation, such as a list of bullet points or a short paragraph summarizing key insights. The server may specify constraints in the prompt sentences to the generative AI model, requiring a particular output structure (for example, numbered lists, labeled sections, or tagged concepts). This structured summary provides a more machine-usable representation than a raw conversation transcript and can be indexed and searched more efficiently.

The server associates knowledge information and related content with access control information. The server creates access control records indicating user groups, roles, or organizational units that are permitted to access particular knowledge items or content. The server stores these access control records together with references to the knowledge information and related content in management data records. The server uploads these records to a data management system, such as an internal knowledge repository, using a programmatic interface. This arrangement ensures that only authorized terminals can retrieve and display specific knowledge items, and allows the data management system to apply optimized indexing and caching strategies at the granularity of knowledge items.

The server constructs recommendation information suitable for display on the terminal by organizing related content and associated knowledge information into a structured data format. The server orders recommendation items according to an importance level computed from relevance scores, inferred user interest levels, and emotional states. The server transmits the recommendation information to the terminal as a compact payload that includes titles, short summaries, uniform resource locators, icons indicating content type, and optional tags.

The server optionally evaluates an emotional state from conversation data by applying an emotion analysis algorithm. The server uses the natural language processing program to extract features such as sentiment-bearing words, punctuation patterns, and syntactic structures, and maps these features to an emotional state label or score by using a classifier model trained with supervised learning. The classifier minimizes a loss function, such as cross-entropy between predicted labels and human-annotated labels, and updates its weights by gradient descent. The server uses the emotional state to modulate importance levels of related content and knowledge information. For example, if the conversation expresses confusion or frustration about a specific technical topic, the server increases the importance of basic tutorials or explanatory content and decreases the importance of highly advanced technical papers. This dynamic adjustment leads to a ranking of content that better matches the user's immediate cognitive state and reduces the number of irrelevant items transmitted and rendered by the terminal.

The server may detect trigger events in the communication platform. The server monitors conversation data for predetermined symbols, phrases, or actions, such as a special command marker, a mention of the system, or a reaction icon. When the server detects such a trigger, the server automatically generates a prompt sentence using the current conversation context and keywords and initiates the processing pipeline described above. This event-driven behavior reduces unnecessary processing and network usage, because the server performs heavier generative AI model calls and search operations only when the user indicates interest. By contrast, a naive system that continuously analyzes every message would spend significant computational resources on conversations that do not require recommendations or knowledge extraction.

The server improves computer technology in several ways. The server reduces computational load on the generative AI model by pre-filtering conversation data through deterministic keyword extraction and normalization, thereby shortening input sequences and decreasing the number of floating-point operations required for model inference. The server improves retrieval quality by using generative AI model outputs as structured, context-aware search query sentences rather than relying on raw user text or simple keyword concatenation. This results in higher precision and recall in search results, which in turn reduces repeated user queries and network traffic. The server improves storage utilization by converting long, redundant conversation histories into compact knowledge information, which is easier to index and cache in a data management system. The server decreases latency by structuring the data flow into optimized modules, where each module operates on standardized data structures with limited size.

The server uses processing logic and prompt construction strategies that differ from conventional human workflows. The server does not merely automate a human annotator's reading and summarizing of conversations; instead, the server applies specific, machine-oriented rules for tokenization, normalization, keyword extraction, and prompt sentence generation that exploit the strengths of neural language models and search engines. For example, the server enforces limits on the number of keywords and the length of conversation excerpts, chooses canonical forms of entities, and encodes instructions to the generative AI model to produce outputs in constrained formats that are directly parseable by downstream modules. These non-conventional procedures enable the system to achieve higher throughput, lower error rates in matching topics to content, and improved reproducibility of results across repeated executions.

The terminal renders recommendation information in a user interface optimized for low-latency interaction. The terminal parses the structured recommendation information and arranges it in a view that groups items by topic or source. The terminal may preload thumbnails or short excerpts in background threads to reduce perceived latency. By receiving only relevant recommendations and compact knowledge information, the terminal reduces energy consumption and bandwidth use compared to fetching raw, unfiltered search results. The user views recommended content on the terminal and may further refine interests by continuing the conversation. The terminal sends subsequent conversation data back to the server, allowing the server to refine its keyword set, prompt sentences, and recommendation strategy over time.

In alternative embodiments, the server may deploy different natural language processing programs, such as other tokenization libraries or morphological analyzers, while retaining the general architecture of normalization, keyword extraction, and prompt sentence generation. The server may use different generative AI models, including models with varying numbers of layers, attention heads, and hidden dimensions, provided that they process prompt sentences and generate text. The server may integrate different emotion analysis algorithms, such as lexicon-based methods or transformer-based classifiers. The server may store data in alternative data structures, such as document-oriented stores or graph databases, as long as conversation data, keywords, prompt sentences, related content, knowledge information, and management data remain associated through identifiers and can be retrieved efficiently.

In another embodiment, the server may run in a distributed environment where separate physical or virtual machines handle conversation ingestion, natural language processing, generative AI model interfacing, and storage. In such an arrangement, the server components communicate over internal networks, and each component may scale independently according to load. The underlying inventive concept remains the orchestration of natural language processing, generative AI model prompt sentence generation, search query generation, and knowledge information creation in a way that improves the operational characteristics of the whole computing system, including precision of retrieval, speed of response, and efficiency of resource usage.

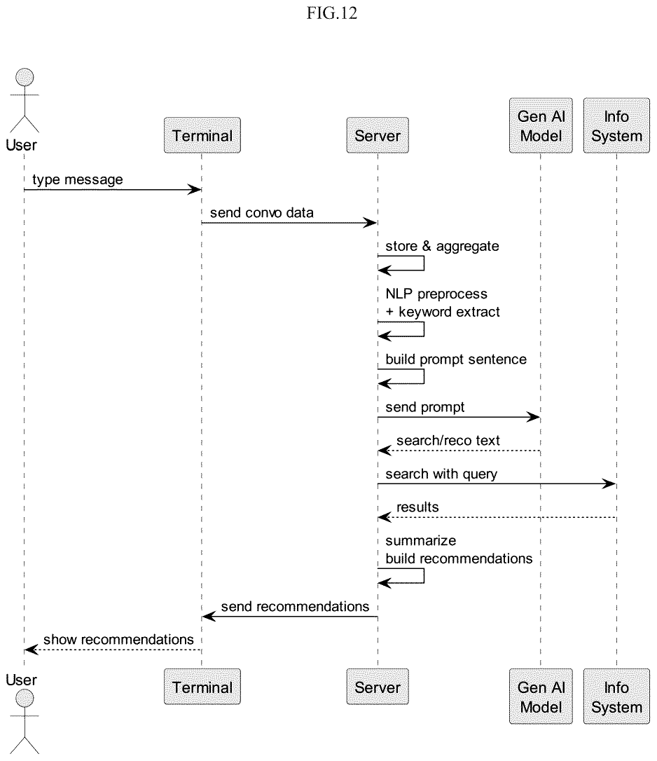

The following describes the processing flow using FIG. 12.

### Step 1:

The user inputs conversation text on the terminal.
The terminal displays a communication platform interface and allows the user to enter messages, reactions, or commands. The terminal receives a text string as input from the user, along with local metadata such as a timestamp and a channel identifier. The terminal converts these elements into a structured message object including fields such as user ID, channel ID, timestamp, and message text. The terminal outputs the structured message object for transmission to the server.

### Step 2:

The terminal transmits structured conversation data to the server.
The terminal receives the structured message object as input and serializes it into a network message, for example a JSON payload conforming to a predefined schema. The terminal attaches authentication information and routing information to the network message. The terminal sends the network message via a network interface using a secure protocol to a designated endpoint of the server. The terminal outputs the network message on the communication channel as a request addressed to the server.

### Step 3:

The server receives and stores raw conversation records.
The server receives the network message from the terminal as input through a network interface. The server parses the payload to reconstruct the structured message object and validates required fields such as user ID and message text. The server generates or updates a conversation session identifier associated with the message and stores a conversation record in a database, including the raw text and metadata. The server outputs a stored conversation record that is retrievable for subsequent analysis.

### Step 4:

The server aggregates conversation data for analysis.
The server receives as input a selection criterion, such as a user identifier or a session identifier, and retrieves a set of conversation records from the database that satisfy the criterion. The server orders the retrieved records by timestamp and concatenates their text fields or arranges them into a list of utterances. The server limits the number or total length of messages to a configurable window size. The server outputs an aggregated conversation segment that represents recent context for the user or session.

### Step 5:

The server preprocesses conversation text using a natural language processing program.
The server receives the aggregated conversation segment as input and invokes a natural language processing program, such as a spaCy-based or NLTK-based module, on the processor. The server applies segmentation to divide the text into sentences and applies normalization to convert characters and tokens into canonical forms. The server applies filters to remove unnecessary information, such as URLs, markup tokens, and predefined stop-words, by matching against regular-expression patterns and lexicons. As a result, the server transforms the raw text into a cleaned token sequence with sentence boundaries and normalized forms. The server outputs the cleaned and segmented text along with token-level annotations.

### Step 6:

The server extracts keywords and phrases from the cleaned text.
The server receives the cleaned and segmented text as input and applies part-of-speech tagging and dependency parsing using the natural language processing program. The server identifies candidate keywords by selecting tokens with noun or proper noun tags and relevant verb tags, and groups adjacent tokens into phrases when dependency relations indicate compound terms. The server calculates frequency statistics for each candidate keyword over the aggregated conversation segment and optionally over a broader historical window. The server filters out low-importance tokens using threshold rules and a domain-specific stop-word list. The server outputs a ranked list of keywords and key phrases that summarize the main topics in the conversation.

### Step 7:

The server selects representative conversation excerpts.
The server receives the aggregated conversation segment and the ranked keyword list as input. The server identifies sentences that contain one or more of the top-ranked keywords and prioritizes recent sentences. The server selects a subset of sentences under a maximum length constraint to maintain efficiency for downstream processing. The server concatenates the selected sentences into a conversation excerpt that preserves conversational context around the key topics. The server outputs the conversation excerpt as a compact representation of the user's current interests.

### Step 8:

The server constructs a prompt sentence for a generative AI model.
The server receives the ranked keyword list and the conversation excerpt as input. The server inserts the keywords and the excerpt into a predefined natural language template that encodes explicit instructions for the generative AI model. The server may specify the number of search queries to generate, the target content type, or the desired language. For example, the server may generate a prompt sentence such as:
“Based on the following user conversation and keywords, infer the user's interests and generate three concise search queries for relevant technical articles. Conversation: ‘I've been really interested in the recent evolution of technology, especially AI and robotics.’ Keywords: ‘technology evolution’, ‘AI’, ‘robotics’.”
The server outputs a complete prompt sentence that instructs the generative AI model to produce a search query sentence or a recommendation prompt sentence.

### Step 9:

The server encodes and transmits the prompt sentence to the generative AI model.
The server receives the prompt sentence as input and passes it to a generative AI model client module. The server tokenizes the prompt sentence according to the vocabulary of the generative AI model and constructs a request object including the token sequence and generation parameters such as maximum token length, temperature, and sampling method.
The server transmits the request over a network or an internal interface to the generative AI model service. The server outputs the request to the generative AI model for inference.

### Step 10:

The server obtains search query sentences and recommendation prompt sentences from the generative AI model.
The server receives model output tokens from the generative AI model as input. The server decodes the tokens into one or more text strings and segments the text into individual query candidates according to delimiters or list markers. The server optionally applies pattern checks to ensure that each candidate conforms to a desired format, such as a natural-language search query or a directive-type recommendation prompt. The server selects one or more valid search query sentences and recommendation prompt sentences. The server outputs the selected search query sentences and recommendation prompt sentences for use in retrieval and recommendation operations.

### Step 11:

The server executes searches in information storage systems and external information providing systems.
The server receives the search query sentences as input and maps each query into the query language required by a target information storage system. The server performs tokenization and field mapping, and optionally expands the query with synonyms or related terms based on a thesaurus. The server sends the queries to internal storage systems, such as full-text indexes, and to external information providing systems via application programming interfaces. The server receives ranked result lists as responses and merges, normalizes, and de-duplicates the returned items. The server outputs a unified list of related content items, each with metadata including an identifier, title, short description, link, and relevance score.

### Step 12:

The server generates knowledge information by summarizing conversation data and related content.
The server receives the aggregated conversation segment, the related content list, and optionally one or more recommendation prompt sentences as input. The server selects a subset of content items with the highest relevance scores and extracts short snippets or abstracts from those items. The server constructs another prompt sentence directed to the generative AI model, instructing it to summarize key insights or trends across the conversation and the content. The server transmits this prompt to the generative AI model and receives a generated summary. The server may also apply rule-based post-processing, such as splitting the summary into bullet points or sections. The server outputs structured knowledge information that distills the essential technical points and relationships.

### Step 13:

The server associates knowledge information and related content with access control information to create management data.
The server receives the knowledge information and related content identifiers as input, along with organizational policy data specified by administrators. The server determines which user groups or roles are permitted to access each knowledge item and content item, and encodes these permissions as access control information. The server bundles the knowledge information, references to related content, and the access control information into management data records. The server stores these records in a data management system or uploads them via an interface. The server outputs management data that can be searched, retrieved, and enforced for access control.

### Step 14:

The server computes importance levels and ranks recommendation items.
The server receives the related content list, the knowledge information, and optionally emotion analysis results and inferred user interest levels as input. The server computes an importance level for each content item and knowledge item by combining factors such as relevance score, recency, emotional state, and interest level through a scoring function. The server sorts items in descending order of importance, and groups items by topic or content type if necessary. The server outputs an ordered set of recommendation items ready for presentation on the terminal.

### Step 15:

The server constructs a recommendation payload and sends it to the terminal.
The server receives the ordered recommendation items and associated knowledge information as input. The server formats each item into a display-ready structure, for example including a title, short summary, content type indicator, and link. The server aggregates multiple items into a payload object and compresses or otherwise optimizes the payload to reduce transmission size. The server sends the payload to the terminal over the network using a response message. The server outputs the recommendation payload as a network response capable of being rendered on the terminal.

### Step 16:

The terminal renders recommendation information for the user.
The terminal receives the recommendation payload as input from the server and parses its structured fields. The terminal maps each item to user interface components, such as list elements, cards, or tiles, and arranges them in the order specified by the importance levels. The terminal displays the titles, summaries, and icons, and attaches interaction handlers to links or buttons so that the user can select content. The terminal outputs a visual presentation on the display that allows the user to browse and access recommended content and knowledge information.

### Step 17:

The user interacts with recommended content and provides further conversation input.
The user receives the visual presentation on the terminal as input and selects one or more recommendation items by tapping or clicking. The user views the linked article, document, or media and may return to the communication platform interface to express new questions, feedback, or interests. The user enters additional conversation text, which the terminal captures and converts into structured conversation data. The user thereby outputs new conversational input that again becomes the input to the processing flow starting from Step 1, enabling iterative refinement of keywords, prompt sentences, and recommendations.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information processing systems that analyze communication data and document data typically rely on separate components for text preprocessing, information extraction, topic grouping, summarization, and access control. These components are often loosely integrated, rule-based, or manually orchestrated. As a result, such systems suffer from several technical problems, including high computational overhead due to redundant processing, poor scalability when handling large volumes of unstructured text, and difficulty in dynamically adapting summarization behavior to varying user instructions and real-time communication context.

In particular, existing systems generally treat a generative artificial intelligence model as a black-box text generator, without tightly coupling internal topic structures, prompt sentences, and summarization constraints. Consequently, the systems are unable to consistently generate topic-specific summaries that are optimized for different users, use cases, and communication environments. Furthermore, conventional systems lack mechanisms to automatically detect trigger expressions in ongoing communication, and to automatically initiate information-extraction and summarization workflows in response. This leads to delays, increased manual intervention, and inefficient use of processing resources.

Additionally, most systems do not integrate emotion analysis into the core pipeline for weighting the importance of information units and adjusting the presentation order of summary data. Without such integration, the systems are not able to prioritize content that is emotionally salient or contextually critical in large-scale organizational communications. This limitation reduces the effectiveness of summaries as decision-support tools and imposes additional cognitive load on users who must manually sift through large amounts of text. From a computer-technology perspective, there is a need for an improved architecture and processing method that: (i) generates and uses internal representation data to minimize redundant natural language processing; (ii) derives structured, topic-wise information suitable for input to a generative artificial intelligence model; (iii) automatically constructs and transmits prompt sentences and generation instruction sentences that encode topic-specific constraints; and (iv) integrates access control and organizational sharing into a unified pipeline. Such an architecture should improve processing efficiency, responsiveness, and relevance of generated summaries, thereby improving the technical functioning of the computer system itself, rather than merely implementing a business or mental process on a generic computer. The present invention has been made in view of these problems.

The specific processing by the specific processing unit 290 of the data processing device 12 in Example 2 is realized by the following means.

The present invention provides a server comprising a processor and a memory storing instructions that, when executed by the processor, cause the processor to acquire interaction data on a communication platform and character information input from an external source; perform, by execution of a document-analysis program, preprocessing including morphological segmentation, removal of non-informative terms, and normalization of word forms on the interaction data and the character information to generate internal representation data suitable for downstream analysis; execute text-mining processing including word frequency analysis, term importance calculation, topic extraction, and grouping on the internal representation data to classify information units into topic-wise groups and generate structured information associated with respective topics; control a generative artificial intelligence model, on the basis of the structured information and a prompt sentence including an instruction statement input from a user, to execute summary generation processing and to generate summary information for each topic; reorganize, by execution of a natural language processing program, the summary information for each topic obtained from the generative artificial intelligence model on the basis of relevance and importance of information, and integrate the reorganized summary information as summary data in a predetermined format; register the summary data in an information-management platform and set usage authorization on the information-management platform according to at least one of an organization unit, a user unit, and an attribute unit to make the summary data shareable across an organization; detect a dialogue including a predetermined invocation expression or symbol on the communication platform and, in response, generate and transmit a prompt sentence that instructs the generative artificial intelligence model to treat the dialogue as a target of information-extraction processing; and optionally evaluate an emotional state for text data by execution of an emotion-analysis program, weight importance of information units included in the structured information and the summary data on the basis of the emotional state, and adjust at least one of a display order and a presentation priority of the summary data according to a result of the weighting. This enables the server to implement an integrated, computer-implemented pipeline that transforms raw communication and document data into topic-wise structured representations optimized for generative artificial intelligence summarization, reduces redundant processing by using shared internal representations, automatically adapts summaries to user instructions and communication context through dynamically constructed prompt sentences and generation instruction sentences, and improves the technical performance of the system in terms of processing efficiency, responsiveness, and relevance of output summaries for large-scale organizational use.

The term “system” refers to an arrangement of one or more hardware devices and software components that cooperate to execute information processing functions as claimed, including at least a processor and associated memory.

The term “processor” refers to a hardware computation unit, such as a central processing unit or a processing core, capable of executing machine-readable instructions to perform operations including data acquisition, analysis, control of external models, and generation of output data.

The term “memory” refers to a hardware storage medium, such as volatile memory or non-volatile memory, that stores instructions and data used by the processor during execution of the claimed processes.

The term “interaction data” refers to textual content and associated metadata generated by exchanges between users on a communication platform, including messages, comments, posts, replies, and similar dialog elements.

The term “communication platform” refers to an electronic communication environment implemented by computing resources, in which users exchange messages or other communication data, such as a messaging service, chat system, collaboration tool, or similar communication service.

The term “character information” refers to information expressed as text, including alphanumeric characters, symbols, and punctuation, that is input from external sources such as files, documents, or user interfaces.

The term “external source” refers to any data origin outside the processing core of the system, including user terminals, data storage services, document repositories, or network-accessible information sources.

The term “document-analysis program” refers to a software component or collection of software components configured to perform analysis and transformation of text data, including segmentation, normalization, and other natural language processing operations.

The term “preprocessing” refers to a series of transformations applied to raw text data prior to higher-level analysis, including segmentation, filtering, normalization, and conversion into an internal representation suitable for further processing.

The term “morphological segmentation” refers to a process of dividing text into minimal linguistic units, such as words, stems, or morphemes, based on the morphological structure of the language.

The term “removal of non-informative terms” refers to filtering operations that exclude words or tokens considered to carry low semantic value for the intended analysis, such as function words, common stopwords, or noise tokens.

The term “normalization of word forms” refers to converting different surface forms of words into a canonical representation, such as base forms, lemmas, or stems, to reduce variability in text data.

The term “internal representation data” refers to a structured or semi-structured data format derived from raw text through preprocessing, designed to efficiently support subsequent computation such as text mining, topic extraction, and summarization.

The term “text-mining processing” refers to computational procedures applied to text-based internal representation data for the purpose of discovering patterns, extracting features, and deriving structured information, including statistical and linguistic analyses.

The term “word frequency analysis” refers to a computation that counts occurrences of words or tokens in a text corpus and may calculate derived measures based on occurrence counts.

The term “term importance calculation” refers to computation of measures that indicate the importance or relevance of terms in a corpus, such as weighting schemes based on frequency, distribution, or contextual prominence.

The term “topic extraction” refers to a process of identifying latent themes or subjects within text data by analyzing patterns of term usage and co-occurrence.

The term “grouping” refers to organizing information units, such as sentences, paragraphs, or documents, into collections based on similarity, topic, or other criteria.

The term “information unit” refers to a discrete segment of content derived from text data, such as a token, phrase, sentence, paragraph, or document, treated as a minimal element for analysis or summarization.

The term “topic-wise group” refers to a set of information units associated with a common topic or theme, derived from topic extraction or clustering processes.

The term “structured information” refers to information represented in an organized data structure, such as records, lists, or mappings, where relationships between topics, information units, and attributes are explicitly encoded.

The term “generative artificial intelligence model” refers to a computational model based on machine learning techniques, such as neural networks, configured to generate or transform natural language text based on input data and control signals.

The term “prompt sentence” refers to a text instruction provided to a generative artificial intelligence model, including directives, constraints, and contextual information that guide the model's generation behavior.

The term “instruction statement” refers to a portion of a prompt sentence that explicitly specifies an operation to be performed by the generative artificial intelligence model, such as summarization, explanation, or reformulation.

The term “summary generation processing” refers to operations performed by the generative artificial intelligence model to produce condensed textual representations that capture salient information from longer input text.

The term “summary information” refers to output text generated by summarization processes that expresses key aspects of source information in a shorter form.

The term “natural language processing program” refers to a software component or library configured to analyze, interpret, and transform text expressed in human language, including tasks such as tokenization, parsing, semantic analysis, and text reorganization.

The term “relevance” refers to a measure indicating how closely a piece of information is related to a given topic, context, or user-defined criterion.

The term “importance” refers to a measure indicating the relative significance or priority of an information unit within a set of information, based on factors such as frequency, centrality, emotional weight, or user-defined rules.

The term “summary data” refers to a data structure that aggregates one or more pieces of summary information, optionally annotated with topic labels, metadata, and formatting attributes, in a predetermined format suitable for storage and presentation.

The term “predetermined format” refers to a predefined structural and syntactic arrangement of data elements, such as a schema, template, or layout, specified by system design for consistent handling of summary data.

The term “information-management platform” refers to a computing environment that stores, organizes, and controls access to information objects, including databases, content management systems, or data repositories.

The term “usage authorization” refers to access control settings or permissions that determine which entities, such as users or groups, are allowed to perform operations on stored information, including viewing, modifying, or sharing.

The term “organization unit” refers to a classification of users or resources corresponding to a structural subdivision of an organization, such as a department, team, or project group.

The term “user unit” refers to an individual user or user account that can be uniquely identified and assigned specific access rights within the system.

The term “attribute unit” refers to a category of users or resources characterized by one or more attributes, such as role, function, location, or security level, used to control access or behavior in the system.

The term “dialogue” refers to a sequence of communication exchanges composed of one or more messages on the communication platform, including posts, replies, and other interactive components.

The term “invocation expression” refers to a specific textual pattern or phrase in a dialogue that indicates a request or trigger for the system to initiate information-extraction or summarization processing.

The term “symbol” refers to a non-alphabetic character or combination of characters, such as special characters or markers, that can act as a trigger indicator within communication data.

The term “information-extraction processing” refers to operations that identify and retrieve specific pieces of information from raw or preprocessed text data according to defined criteria or models.

The term “emotion-analysis program” refers to a software component configured to evaluate emotional states or sentiments expressed in text data, such as positive, negative, neutral, or more fine-grained affective categories.

The term “emotional state” refers to a representation of affective characteristics inferred from text, including sentiment polarity, intensity, or specific emotion categories.

The term “weighting” refers to assigning numerical or categorical values to information units to reflect their relative importance or priority under specified criteria.

The term “display order” refers to the sequence in which information units, such as summary segments or topics, are presented to a user on an output interface.

The term “presentation priority” refers to a ranking or emphasis level used when outputting information units, which may influence placement, visibility, highlighting, or other presentation aspects.

The term “generation instruction sentence” refers to a prompt-like text that encodes specific constraints or parameters for the generative artificial intelligence model, such as summary length, style, and target audience, and that directs how the model should generate output.

The term “constraint conditions” refers to explicit requirements or limits applied to the generative artificial intelligence model's output, including constraints on length, format, style, level of detail, or target readership.

The term “summary length per topic” refers to a constraint that specifies a desired size, such as number of sentences, tokens, or characters, for a summary associated with a particular topic.

The term “representation style” refers to characteristics of the generated text, such as formality level, narrative or bullet-point format, technical depth, or tone.

The term “target user group” refers to a category of intended readers for whom the summary is optimized, such as experts, non-experts, managers, or students, influencing vocabulary, level of detail, and explanation style.

The term “downstream analysis” refers to processing stages that are performed after initial preprocessing, such as text mining, topic extraction, and summarization, which operate on internal representation data.

The term “large-scale organizational use” refers to deployment and operation of the system in an environment with many users, high volumes of communication data, and organizational structures requiring controlled sharing and access management.

In one embodiment, a server implements the claimed system by executing an integrated software stack on a hardware platform including at least one multi-core central processing unit (CPU), a main memory, a non-volatile storage device such as a solid-state drive (SSD), and, in some configurations, a graphics processing unit (GPU) for accelerating neural network computation. The server runs on an operating system such as a Linux-based operating system and executes application software written, for example, in a high-level programming language. A terminal operated by a user is implemented by a computing device such as a desktop computer, a portable computer, or a mobile terminal, and executes a web browser or a dedicated client application to communicate with the server via a network using a protocol such as HTTPS.

The server stores in the memory and executes a document-analysis program, a natural language processing program, a text-mining program, an emotion-analysis program, and a control program that coordinates interaction with a generative AI model. In a typical implementation, the server uses natural language processing libraries such as NLTK and spaCy to implement tokenization, sentence segmentation, stopword removal, and lemmatization. The server uses text-mining libraries such as scikit-learn and a topic modeling library such as Gensim to implement word frequency analysis, term importance calculation, and topic extraction. The server also uses a neural-network-based generative AI model, for example a transformer-based language model similar in structure to GPT-type models or BERT-type encoder-decoder models, accessed either via an external API or hosted locally using a framework such as an open-source transformer library.

The server defines concrete data structures in the memory to support the claimed processing. For example, the server maintains:
(1) a raw message table, implemented as a record list or database table, that stores interaction data obtained from a communication platform, including message identifiers, user identifiers, timestamps, and message text;
(2) a document table that stores character information input from external sources, such as uploaded documents, together with metadata such as file type, source, and creation time;
(3) an internal representation store, implemented as a set of token sequences, term-frequency vectors, and topic-distribution vectors, derived from the raw text data, where each entry corresponds to an information unit such as a sentence or paragraph;
(4) a topic structure store, which stores structured information representing topic-wise groups of information units, including topic identifiers, lists of associated information units, and statistics such as representative terms and topic probabilities;
(5) a summary store, which stores summary information and aggregated summary data per topic, with associated metadata including the prompt sentence and generation parameters; and
(6) an access control store, which stores usage authorization rules indexed by organization unit, user unit, and attribute unit, used when registering and providing access to summary data in an information-management platform.

The server uses the document-analysis program to transform incoming raw text into internal representation data that is re-used across multiple downstream computations. Specifically, the server uses spaCy to divide incoming text into sentences and tokens, and to compute part-of-speech tags and lemmas. The server stores for each token its surface form, lemma, part-of-speech, and positional index in a token sequence data structure. The server then uses NLTK's stopword lists to flag and optionally remove non-informative tokens. By constructing and reusing this normalized internal representation, the server avoids repeating segmentation and normalization operations in later stages, thereby reducing computational overhead and improving processing speed relative to systems that perform such operations redundantly for each query or analysis.

The server uses the text-mining program to perform word frequency analysis and term importance calculation on the internal representation data. In one implementation, the server uses a term-frequency-inverse-document-frequency (TF-IDF) algorithm provided by scikit-learn. The server constructs a sparse matrix where each row represents an information unit, such as a sentence, and each column represents a term. The server calculates term frequency and inverse document frequency across the corpus, and then multiplies these values to obtain a term importance score for each term in each information unit. The server uses these term importance scores to select candidate keywords and key phrases.

For topic extraction, the server uses a probabilistic topic model such as Latent Dirichlet Allocation (LDA) implemented in Gensim. The server converts the tokenized information units into a bag-of-words representation and feeds this representation into the LDA algorithm, which computes for each information unit a distribution over topics and for each topic a distribution over terms. In one embodiment, the server stores for each information unit a topic vector and assigns the information unit to the topic having the highest probability, provided that the probability exceeds a threshold. The server then constructs the topic structure store as a mapping from topic identifiers to lists of information units, together with representative terms for each topic derived from top-ranked terms in the term distribution. This structured representation yields a more efficient input for subsequent summarization, because the generative AI model can be conditioned on specific topics instead of processing the entire corpus indiscriminately.

The server integrates a transformer-based generative AI model as a core component for summary generation. In one embodiment, the generative AI model is a deep neural network comprising a stack of self-attention layers, feed-forward layers, layer-normalization units, and positional encoding, similar to architectures used in large language models. The server stores model parameters including token embedding weights, positional encoding parameters, attention projection matrices, feed-forward weights, and layer-normalization parameters. The model is trained in advance on a large corpus of textual data using an objective function such as next-token prediction or denoising autoencoding. During training, the server or a training environment uses an optimization algorithm such as stochastic gradient descent or Adam, and an error function such as cross-entropy between predicted token distributions and ground-truth token sequences. Weights are updated by backpropagation based on gradients computed from the error function. Data augmentation techniques such as random masking, sentence shuffling, and noise injection may be used in pretraining to increase robustness. In some embodiments, the server fine-tunes the generative AI model on domain-specific corpora of communication-platform messages and documents to improve summarization quality for that environment, using supervised data pairs of original text and reference summaries.

The server implements control logic to construct prompt sentences and generation instruction sentences that explicitly encode constraints and context for the generative AI model. The server analyzes user-provided instruction statements, such as:
“Please summarize the latest technology news by theme.”
“Please extract the main topics and summarize the latest AI research articles.”
“Summarize the following text about AI in 4-5 sentences for non-experts.”
“Generate a concise summary in 4-6 sentences, focusing on key innovations, important organizations, and real-world applications.”

The server uses the natural language processing program to parse these instruction statements, detecting tokens and phrases that indicate requested operations (for example, “summarize,” “extract the main topics,” “for non-experts,” “4-5 sentences”). The server then generates a prompt sentence that combines: (i) the user's instruction statement; (ii) metadata about the topic structure, such as topic labels or representative terms; and (iii) explicit constraint conditions on summary length, representation style, and target user group. For example, the server constructs a prompt sentence such as:
“You are an assistant that summarizes technical news by topic. Read the following text about recent developments in AI. Generate a concise summary in 4-6 sentences, focusing on key innovations, important organizations, and real-world applications. Use clear language suitable for non-expert readers.”

The server appends the topic-wise text to this prompt sentence and supplies the resulting token sequence to the generative AI model. Internally, the server converts the prompt sentence and topic text into token identifiers using a tokenizer associated with the model, and stores the resulting token sequence in a model-input buffer. The server configures generation parameters such as maximum token length, minimum token length, temperature, and nucleus-sampling probability (top-p), all stored in a parameter structure referenced by the generation routine. By controlling these parameters and by using topic-wise internal representations, the server achieves consistent response length, readability, and relevance.

For summarization, the generative AI model computes hidden representations for the input token sequence using multiple layers of self-attention and feed-forward computation. Each self-attention layer computes attention weights based on similarity between query, key, and value vectors derived from the input representations. The model then computes an output token distribution for each decoding step, and the server selects tokens by applying the configured sampling strategy. Due to the topic-wise structuring and the constraint conditions encoded in the prompt sentence, the model focuses on the most salient information units for each topic, producing summary information that is both concise and specific. This structured workflow improves computational efficiency compared with naive summarization of the entire corpus; the model processes shorter, topic-filtered inputs, reducing the number of tokens per request and thereby reducing processing time and computing resource consumption.

The server reorganizes the raw summary information produced by the generative AI model using the natural language processing program. The server splits generated text into sentences, normalizes whitespace, and removes duplicated or low-information sentences. The server also maps parts of the summary back to original information units using token-level alignment or similarity metrics, enabling validation and consistency checks. The server then integrates the validated summary information for each topic into summary data that follows a predetermined format, such as a structured document in which each topic has a header, a summary paragraph, and metadata fields. This formal structure supports efficient indexing and retrieval in the information-management platform.

The server registers the summary data into the information-management platform by writing the structured records into a database or content-management system. When registering each summary, the server consults the access control store and determines usage authorization based on organization unit, user unit, and attribute unit. The server stores access-control lists or role-based access rules associated with each summary object, such that only authorized users can read or modify the summary. By tightly integrating summary generation with access control at the data-structure level, the server improves data management and reduces the risk of unauthorized access, while also allowing fine-grained control of which summaries are available to which groups, thereby supporting large-scale organizational use.

In some embodiments, the server detects dialogues including predetermined invocation expressions or symbols on the communication platform. The server subscribes to message streams via an application programming interface exposed by the communication platform and inspects each incoming message. When the server detects a message containing a particular invocation keyword or symbol, such as a predefined hashtag or command phrase, the server marks the associated dialogue as a candidate for information-extraction and summarization processing. In response, the server automatically generates a prompt sentence instructing the generative AI model to treat the dialogue as a target of information-extraction processing, and initiates the internal pipeline using the dialogue as input. This event-driven mechanism reduces latency between user activity and summary availability, and ensures that computational resources are focused on dialogues that explicitly request automatic processing, thereby lowering unnecessary processing and network load.

The server optionally uses an emotion-analysis program to evaluate the emotional state of text data. The server may implement this program using a classifier trained on labeled sentiment data, such as a neural network or other machine-learning model that outputs emotion categories or sentiment scores. The server computes, for each information unit, an emotion vector representing polarity and intensity. The server then uses these emotion vectors as additional features when calculating importance weights for information units during summary organization. Information units with strong emotional content or high relevance to user sentiment can be weighted more heavily and placed higher in the display order. This feature-weighting and ordering process is implemented at the data-structure level, by storing and processing numerical weights associated with each information unit, and thus constitutes an improvement in how the computer system schedules and presents information rather than a mere mental judgment.

The server implements the emotion-based weighting, topic-based structuring, and reusable internal representations as non-conventional, non-generic combinations of operations that improve the functioning of the computer itself. By generating and reusing internal representation data, the server minimizes repeated natural language processing operations across multiple downstream tasks, increasing throughput and reducing CPU and memory load. By partitioning text into topic-wise groups and generating summaries per topic with explicit constraints, the server reduces the number of tokens sent to and processed by the generative AI model, which directly reduces processing time and network usage when an external API is used. By dynamically constructing prompt sentences and generation instruction sentences with constraint conditions, the server produces more predictable, bounded-length outputs, which simplifies buffer management, reduces memory fragmentation, and mitigates the need for expensive post-processing.

The system is not limited to a single model or algorithm. In alternative embodiments, the server may use a BERT-based encoder to compute sentence embeddings and then use a separate decoder-based generative model for summary generation. In another embodiment, the server may use graph-based ranking algorithms, such as a variant of TextRank, on the internal representation data to pre-select candidate sentences for each topic, and then use the generative AI model to rewrite or compress these candidates under the control of prompt sentences. In a further variation, the server may adapt the number of LDA topics dynamically based on document corpus statistics, or may replace LDA with a neural topic model that uses an autoencoder architecture. These variations share the common structure that the server first generates topic-wise structured information and then feeds this information, under explicit constraints, into a generative AI model governed by prompt sentences.

In addition, the server may deploy the generative AI model locally on a GPU-equipped environment. In this case, the server uses a transformer framework to load pre-trained weights and executes matrix multiplications and attention computations on GPU hardware, thereby accelerating inference. The server controls GPU memory allocation by batching topic-wise requests and limiting maximum sequence lengths based on topic-specific constraints derived from the internal representation. This careful management of data structures and resource allocation leads to improved computational efficiency and increased throughput for large-scale deployments.

The terminal provides a user interface that allows the user to view available topics, select topics of interest, and configure summary parameters such as desired length and intended audience. The user inputs prompt sentences directly via an input field, and the terminal transmits these inputs to the server as part of a request message. The terminal receives summary data from the server and renders it according to the metadata, for example by grouping summaries by topic and highlighting high-importance segments indicated by the importance weights computed on the server. In some configurations, the terminal can also present confidence indicators, such as visual bars representing the term importance or topic probability underlying each summary, making use of the structured information maintained by the server.

The user interacts with the system by formulating prompt sentences that describe desired operations or constraints. Because the server parses and interprets these prompt sentences and embeds them into model-specific instruction sequences, the user does not need to manipulate low-level model parameters. The system thus provides a flexible interface while still implementing specific, technically grounded processing steps within the server, including internal representation reuse, topic modeling, emotion-weighted importance calculation, and constrained token generation. These technical arrangements cause the computer to operate in a more efficient, resource-aware manner, and yield summaries that are more accurate and contextually relevant than would be produced by generic, unconstrained summarization applied to entire corpora.

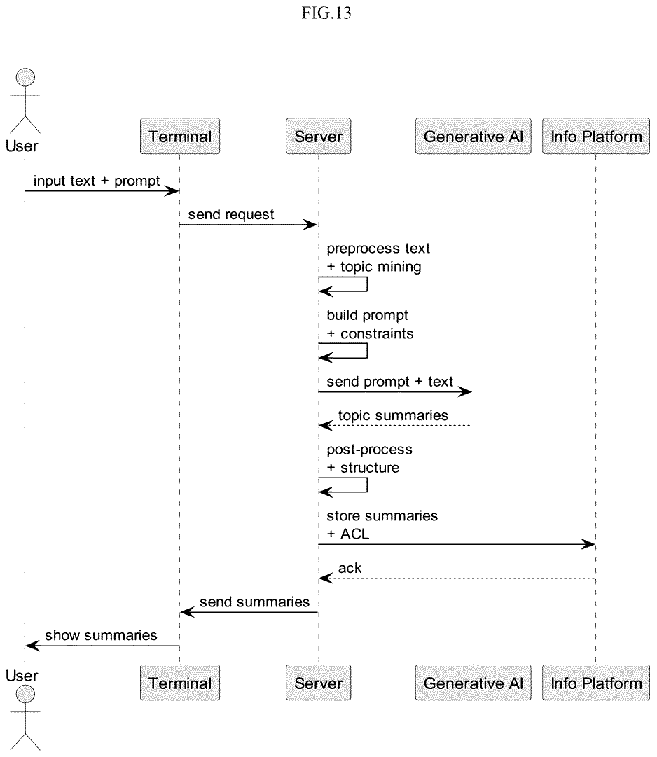

The following describes the processing flow using FIG. 13.

### Step 1:

The user operates the terminal to prepare analysis conditions. The user opens a client application or web browser on the terminal and selects target text sources, such as files, copied text, or communication threads. The user then inputs a prompt sentence, for example “Please summarize the latest technology news by theme,” into an input field. The input of this step is user-selected text sources and a user-entered prompt sentence, and the output is a request object stored in the terminal that includes identifiers of the selected text sources and the prompt sentence.

### Step 2:

The terminal transmits the request object to the server. The terminal converts the selected text sources and the prompt sentence into a structured network request, for example an HTTPS POST message with a header and a body containing the text data and metadata. The input of this step is the request object created in Step 1, and the output is a network message delivered over a communication network to an endpoint exposed by the server.

### Step 3:

The server receives and parses the incoming network message. The server uses a communication module to terminate the HTTPS connection, extract the body of the request, and decode any file attachments or encoded text segments. The server then stores the raw message text, document text, and the prompt sentence in a temporary storage area in memory, each associated with a request identifier. The input of this step is the network message from the terminal, and the output is a set of internal raw text records and a stored prompt sentence ready for preprocessing.

### Step 4:

The server executes a document-analysis program to perform text preprocessing. The server loads the raw text records and uses natural language processing libraries such as NLTK and spaCy to perform sentence segmentation and tokenization. The server converts each text into a sequence of tokens, removes non-informative tokens using a stopword list, and normalizes tokens to their base forms by lemmatization or stemming. The server constructs an internal representation for each information unit, storing token IDs, lemmas, part-of-speech tags, and positions in an internal data structure. The input of this step is the raw text records produced in Step 3, and the output is internal representation data consisting of normalized token sequences and associated linguistic attributes.

### Step 5:

The server performs text-mining processing on the internal representation data. The server uses a text-mining program, for example implemented with scikit-learn and Gensim, to compute term frequencies and inverse document frequencies and to build a term-document matrix. The server applies a topic modeling algorithm such as Latent Dirichlet Allocation to the matrix to obtain topic distributions over information units. The server calculates term importance scores, selects representative terms, and classifies each information unit into a topic based on its highest-probability topic label. The input of this step is the internal representation data from Step 4, and the output is structured information comprising topic-wise groups of information units and associated topic statistics.

### Step 6:

The server analyzes the user's prompt sentence to derive summarization constraints. The server uses the natural language processing program to parse the prompt sentence, detect action words such as “summarize” or “extract topics,” and identify explicit constraints such as “4-5 sentences,” “for non-experts,” or “by theme.” The server converts these textual indications into structured parameters, including requested summary length per topic, target audience type, and focus elements such as “key innovations” or “important organizations.” The input of this step is the stored prompt sentence from Step 3, and the output is a constraint parameter set that the server will use to construct model-specific instructions.

### Step 7:

The server constructs topic-wise prompt sentences and generation instruction sentences for the generative AI model. The server iterates over each topic group in the structured information and builds a composite instruction that includes the user's intent, the topic label, representative terms, and the constraint parameter set. For example, the server creates a prompt sentence such as “You are an assistant that summarizes technical news by topic. Read the following text about recent developments in AI. Generate a concise summary in 4-6 sentences, focusing on key innovations, important organizations, and real-world applications. Use clear language suitable for non-expert readers.” and appends the AI-related text for that topic. The input of this step is the structured information from Step 5 and the constraint parameter set from Step 6, and the output is a collection of topic-wise prompt sentences and corresponding text segments to be supplied to the generative AI model.

### Step 8:

The server prepares and transmits model input data to the generative AI model. The server uses a tokenizer associated with the generative AI model to convert each topic-wise prompt sentence and appended text into numerical token IDs. The server stores the resulting token sequences and applies generation parameters such as maximum length, temperature, and sampling probability. If the generative AI model is accessed via an external API, the server packages the token sequences and generation parameters in an API request and transmits it over the network. If the model is hosted locally, the server writes the token sequences and parameters into model input buffers and invokes a generation routine on a CPU or GPU. The input of this step is the topic-wise prompt sentences and constraint parameters from Step 7, and the output is one or more model invocation requests containing encoded input sequences and configuration parameters.

### Step 9:

The server obtains summary information generated by the generative AI model. The generative AI model executes its internal transformer architecture, calculating attention scores, hidden states, and output token distributions layer by layer, and returns generated token sequences representing summaries. The server receives these sequences either as API responses or as return values from local model calls and decodes them back into text strings using the tokenizer's vocabulary. The input of this step is the model invocation requests from Step 8, and the output is raw summary text for each topic in natural language form.

### Step 10:

The server post-processes and organizes the summary text into summary data. The server uses the natural language processing program to segment the summary text into sentences, remove redundant or malformed sentences, and enforce any final length or formatting constraints that were not fully honored by the model. The server maps each sentence back to its topic label and attaches metadata such as generation time, model identifier, and importance indicators. The server then aggregates the topic-wise summaries into a summary data structure that follows a predetermined format, for example a list of topic entries, each containing a topic label and a corresponding summary paragraph. The input of this step is the raw summary text from Step 9, and the output is structured summary data ready for registration.

### Step 11:

The server registers the summary data in an information-management platform with appropriate access control. The server writes each topic-wise summary into a database or content repository and obtains a persistent identifier for each stored record. The server consults organization unit, user unit, and attribute unit information for the requesting user and constructs usage authorization rules, such as access-control lists or role-based policies. The server associates these rules with the stored summary records so that only authorized users or groups can access them. The input of this step is the structured summary data from Step 10 and user-related metadata from the request context, and the output is a set of stored summary objects with associated access rights in the information-management platform.

### Step 12:

The server optionally adjusts display order and presentation priority using emotion analysis. The server applies an emotion-analysis program to the original information units and to the generated summaries to derive emotion scores, such as sentiment polarity and intensity, for each unit. The server combines these emotion scores with topic importance and term importance to compute a composite weight for each summary segment. The server then reorders summary segments, or marks certain segments as high-priority, based on these weights, updating the summary data structure accordingly. The input of this step is the structured summary data from Step 10 and emotion scores derived from the underlying text, and the output is a prioritized summary data structure where each topic or segment has an associated presentation weight and order.

### Step 13:

The server returns the final summary data to the terminal. The server converts the prioritized summary data into a response format, such as JSON or HTML, embedding topic labels, summary text, and, optionally, importance indicators. The server then transmits this response over the network to the terminal that initiated the request. The input of this step is the prioritized summary data from Step 12 or the unprioritized summary data from Step 11 if emotion analysis is not used, and the output is a response message containing the final summaries.

### Step 14:

The terminal receives and renders the summary information for the user. The terminal decodes the response message and constructs a user interface display in which summaries are grouped by topic and ordered according to the presentation priority assigned by the server. The terminal may highlight higher-weighted segments or provide controls to expand and collapse topic sections. The user then views the summaries and, if desired, inputs a new prompt sentence, such as “Please shorten the AI summary to 2 sentences,” which restarts the sequence from Step 1 with updated constraints. The input of this step is the response message from Step 13, and the output is a visual or interactive presentation of topic-wise summaries on the terminal screen, enabling the user to consume and further refine the generated information.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that handle dialogue data and document data from communication environments or information exchange environments typically treat all text segments as having similar importance and ignore fine-grained emotion states of users. As a result, these systems often generate summaries or reports that either omit highly impactful content or overemphasize minor details, leading to inefficient consumption of information by users. Furthermore, traditional systems usually apply natural language processing in a batch-oriented and static manner, without dynamically adjusting importance scores or document ranking based on evolving user emotions, topics, or contexts. This causes delays in surfacing critical risks, decisions, or achievements in large-scale communication streams.

In addition, known summarization systems that rely on machine learning or generative models frequently send raw or unfiltered text to the underlying models, resulting in unnecessary computational load, increased latency, and higher operating cost. These systems also tend to lack precise control over model behavior because the prompt sentences provided to the generative models are generic and not tailored to specific task types, such as decision extraction, risk detection, or emotion-aware summarization. This leads to inconsistent quality of generated summaries and limits the practical utility of such systems in organizational settings.

Moreover, conventional data management platforms and dashboards are typically unaware of users'emotion states and therefore cannot prioritize documents or alerts in a way that reflects emotional urgency or relevance. Important risk-related content with strongly negative emotions may be buried under neutral or low-impact items, while highly positive outcomes that are important for decision making and knowledge sharing may not be prominently surfaced. Existing approaches also do not fully exploit the interplay between emotion analysis, importance scoring, and prompt-controlled generative AI processing to automatically generate targeted outputs, such as risk alerts, emotion-sensitive summaries, or decision-focused reports.

Accordingly, there is a need for an improved computer-implemented system that (i) preprocesses and structures dialogue and document data into text units with associated topic, role, and emotion information; (ii) computes and dynamically adjusts importance scores based on both text features and emotion states; (iii) constructs task-specific prompt sentences and uses them to control a generative AI model to produce high-quality summary texts and analysis-result texts; and (iv) integrates these outputs with a data management or data sharing platform that can rank and present documents according to importance and emotion, while supporting emotion-driven risk detection and alerting. Such a system should improve the efficiency, accuracy, and responsiveness of computer processing of large-scale communication data, thereby enhancing the overall performance of the underlying computing infrastructure.

The specific processing by the specific processing unit 290 of the data processing device 12 in Application Example 2 is realized by the following means.

The present invention provides a server comprising a processor configured to acquire dialogue data or document data from at least one of a communication environment and an information exchange environment, to identify a plurality of related utterances or descriptions based on source identifiers and time information, and to perform preprocessing to convert the utterances or descriptions into structured text data; to execute natural language processing on the structured text data, the natural language processing including at least one of keyword extraction, topic classification, utterance-segment labeling, and emotion-state estimation, in order to assign topic information, role information, and emotion information to respective text units and to calculate base importance values based on text features; to adjust the base importance values based on the emotion information so as to generate importance scores for the text units or document units, and to select a subset of the text units or document units in accordance with the importance scores; to generate, using the selected subset as input, an input text for a generative AI model by combining the input with a prompt sentence generated according to a task type, and to cause the generative AI model to output at least one of a summary text and an analysis-result text; to format the output text into a document structure including headings, list expressions, and metadata, to associate the emotion information and the importance scores with the document structure, and to register the document structure in at least one of a data management platform and a data sharing platform while setting access rights so that the document structure is usable within at least one organization; and to, in response to at least one of a request from a user terminal and detection of a specific expression or a mention in the user terminal, rank a plurality of registered document structures based on the importance scores and the emotion information and transmit a result of the ranking to the user terminal. This enables improved computer-implemented processing of large-scale communication data by reducing the amount of text sent to the generative AI model, by tailoring model behavior through task-specific prompt sentences, by dynamically prioritizing information using emotion-aware importance scores, and by automatically generating and distributing summaries and alerts that cause client devices and data management platforms to surface critical content with reduced latency and improved relevance.

The term “system” refers to a combination of hardware and software components that cooperate to perform information processing, including at least one server-side processor and one or more user terminals interconnected via a communication network.

The term “processor” refers to one or more hardware processing units, such as a central processing unit or a processing core, configured to execute instructions that implement the functions described herein.

The term “communication environment” refers to an electronic communication context in which users exchange messages, including but not limited to messaging platforms, chat services, groupware systems, and other network-based dialogue systems.

The term “information exchange environment” refers to an electronic environment in which users or systems exchange data or content, including but not limited to forums, collaborative platforms, news feeds, and data sharing services.

The term “dialogue data” refers to text data representing one or more utterances exchanged between two or more participants in a communication environment or information exchange environment.

The term “document data” refers to text data representing one or more documents, such as articles, reports, logs, or other structured or unstructured textual content.

The term “source identifier” refers to information that uniquely or logically identifies an origin of dialogue data or document data, such as a channel identifier, thread identifier, user identifier, or content identifier.

The term “time information” refers to temporal data associated with dialogue data or document data, including timestamps, time ranges, or sequence indices used to relate multiple utterances or descriptions.

The term “utterance” refers to a unit of dialogue, such as a single message, sentence, or turn, generated by a participant in a communication environment.

The term “description” refers to a unit of document content, such as a sentence, paragraph, or section, that describes information in document data.

The term “preprocessing” refers to a set of operations performed on raw text to transform it into a normalized and analyzable form, including at least one of cleaning, tokenizing, normalizing, and segmenting.

The term “structured text data” refers to text data that has been processed to include explicit structure or annotations, such as segmentation, tokens, labels, or metadata, enabling further automated analysis.

The term “natural language processing” refers to computational techniques for analyzing and transforming human language text, including at least one of tokenization, tagging, parsing, classification, and semantic analysis.

The term “keyword extraction” refers to a process of identifying words or phrases that are representative or salient within a text, based on statistical, linguistic, or model-based criteria.

The term “topic classification” refers to a process of assigning one or more topic categories to a text unit based on its content.

The term “utterance-segment labeling” refers to a process of assigning functional or structural labels to segments of dialogue or document text, such as labels indicating problems, decisions, actions, or feedback.

The term “emotion-state estimation” refers to a process of analyzing text to infer an emotional condition of a user, such as joy, excitement, anxiety, anger, or neutrality.

The term “text unit” refers to a smallest processing unit of text handled by the system, such as a sentence, message, utterance segment, or paragraph.

The term “topic information” refers to data indicating one or more topics associated with a text unit, such as a category name, tag, or topic identifier.

The term “role information” refers to data indicating a functional role of a text unit within a conversation or document, such as whether the text unit corresponds to a decision, an action item, a problem statement, or a remark.

The term “emotion information” refers to data representing an estimated emotion state associated with a text unit, including emotion categories and optionally numerical intensity values.

The term “base importance value” refers to an initial numerical measure that represents an importance of a text unit computed from text features before adjustment using emotion information.

The term “text features” refers to measurable attributes of text units used for analysis, including but not limited to term frequencies, keyphrase scores, positional information, and label types.

The term “importance score” refers to a numerical measure representing an importance of a text unit or document unit after adjustment based on emotion information, used for at least one of viewing, notification, and storage.

The term “document unit” refers to a larger text aggregation such as an entire document, a section, or a group of related text units treated as a single entity for scoring or selection.

The term “generative AI model” refers to a machine learning model configured to generate text outputs in response to text inputs, such as a neural network-based language model.

The term “prompt sentence” refers to text that instructs the generative AI model regarding a desired task or behavior, such as summarization, extraction of decisions, or risk analysis.

The term “input text” refers to text provided as input to the generative AI model, including at least one prompt sentence and one or more text units or document units.

The term “summary text” refers to a text output generated by the generative AI model that provides a condensed representation of content derived from input dialogue data or document data.

The term “analysis-result text” refers to a text output generated by the generative AI model that presents results of an analysis, such as extracted decisions, risks, sentiment evaluations, or categorized information.

The term “document format” refers to a structured representation of text for storage or presentation, including elements such as headings, list expressions, sections, and associated metadata.

The term “heading” refers to a text element that denotes a title or label for a section of a document format.

The term “list expression” refers to a representation of information in a list form, such as bullet lists or numbered lists.

The term “metadata” refers to auxiliary data associated with a document format, such as source information, timestamps, user identifiers, emotion information, and importance scores.

The term “data management platform” refers to an information system configured to store, manage, and provide controlled access to data objects, including document formats generated by the processor.

The term “data sharing platform” refers to an information system configured to allow multiple users or systems to share and access stored data objects across organizational boundaries or units.

The term “access rights” refers to control information that defines which users or systems are permitted to access, read, write, or modify a document format or related data.

The term “organization” refers to a group of users or entities, such as a business unit, team, or enterprise, that shares access to data through a data management platform or data sharing platform.

The term “user terminal” refers to an electronic device operated by a user, such as a mobile device, wearable device, or computing device, configured to send requests and receive results from the system.

The term “specific expression” refers to a predetermined text pattern in user input, such as a keyword, phrase, or symbol, that the system recognizes as a trigger condition.

The term “mention” refers to a reference to a particular entity or service in user input, typically expressed using a special syntax, that the system recognizes as a trigger to initiate processing.

The term “ranking” refers to an operation of ordering a plurality of document formats or items based on one or more criteria, such as importance scores and emotion information.

The term “time-series change” refers to variation of a value, such as a user emotion state, over time as measured across multiple observations.

The term “topic-wise emotion tendency” refers to a pattern of emotion states associated with a specific topic, aggregated from multiple text units related to that topic.

The term “abnormal emotion change” refers to a change in emotion information that exceeds a predetermined threshold relative to a baseline or expected pattern.

The term “risk-information extraction” refers to an operation of identifying and outputting information that indicates potential problems, threats, or adverse events from text data.

The term “warning information” refers to information generated by the system to alert a user or administrator to a condition of concern, such as an abnormal emotion change or a detected risk.

The term “trigger” refers to an event or condition, such as detection of a specific mention or keyword, that causes the processor to start or modify an information processing operation.

The term “dialogue range” refers to a subset of dialogue data, defined by time boundaries, message indices, or structural criteria, that is processed together in response to a trigger.

The term “task description” refers to explanatory text within a prompt sentence that specifies what processing the generative AI model should perform on the input text.

The term “automatic generation” refers to a process in which the system, without human intervention during execution, produces an output text such as a summary text or an analysis-result text using the generative AI model.

In one embodiment, a server executes an information processing program on a hardware platform including at least one central processing unit, a main memory, a non-volatile storage device, and a network interface connected to a communication network. The server uses a general-purpose operating system and an application stack including, for example, a web application framework, a relational database management system, and a message queue system. The server communicates with at least one terminal operated by a user, where the terminal may be a smartphone, a tablet, a wearable device such as smart glasses, or a personal computer. The terminal executes a client application that interacts with communication environments and information exchange environments, and that sends data and commands to the server.

The server implements a set of software modules written, for example, in a high-level programming language. The server includes a communication acquisition module, a preprocessing module, a natural language processing module, an emotion analysis module, an importance scoring module, a generative AI interface module, a document formatting module, a storage and access-control module, and a ranking and delivery module. The server coordinates these modules using in-memory data structures such as hash maps, lists, and graph-like structures, as well as persistent structures such as relational tables and key-value records. By structuring the processing in this modular and data-centric manner, the server reduces unnecessary data transfer between components and lowers latency compared to naive batch pipelines.

The server acquires dialogue data and document data from external communication environments and information exchange environments via standardized application programming interfaces. For example, the server may communicate with a messaging platform API using HTTPS requests and responses encoded in a structured data format. The server may also access forum logs or news feeds via HTTP endpoints and parse structured or semi-structured responses. The server stores the acquired raw data in a database table where each record contains at least a source identifier, a timestamp, a user identifier, a channel identifier, and a text field.

The server performs text preprocessing using a preprocessing module. The server normalizes character encodings, removes markup tags, replaces control characters, and splits text into sentences and tokens. The server can use, by way of example, natural language processing libraries that provide tokenization, lemmatization, and part-of-speech tagging functions. The server constructs structured text data objects that store, for each text unit, an ordered list of tokens, token positions, part-of-speech tags, and references to the original dialogue or document. These structured objects are stored in memory and, when needed, serialized to the database with explicit foreign keys to the raw data records. This explicit structuring of text units into well-defined data objects allows downstream modules to operate on compact, indexed representations rather than long raw strings, which improves cache locality and processing throughput.

The server applies natural language processing to the structured text data using the natural language processing module. The server computes term frequency-inverse document frequency values for tokens, applies graph-based algorithms to rank candidate keywords, and performs topic classification by feeding vector representations of text units into a classifier.

The server may use a transformer-based encoder network that maps each text unit to an embedding vector; the network may include multiple self-attention layers, feed-forward layers, and layer-normalization components. The server stores, for each text unit, topic information, role labels, and intermediate features such as embedding vectors in dedicated tables. The use of embedding vectors and topic labels enables the server to cluster related text units and reduces the need for repeated full-text scanning, improving computational efficiency.

The server estimates user emotion states with the emotion analysis module. The server converts each text unit into a feature vector that may include lexical features (for example, counts of positive and negative words), syntactic features (for example, exclamation frequency), and semantic features (for example, transformer embeddings). The server inputs these vectors into a trained neural network configured for multi-class emotion classification. In one embodiment, the neural network is a multi-layer perceptron with several hidden layers using rectified linear activation functions, a softmax output layer that yields probabilities for emotion categories such as joy, excitement, anxiety, anger, and neutrality, and a cross-entropy loss function used during training. The server may train this network offline using labeled dialogue corpora, applying backpropagation with an optimizer such as stochastic gradient descent or an adaptive gradient method. During inference, the server uses fixed learned weights. By using learned, high-dimensional feature mappings rather than manually defined sentiment rules, the server detects subtle emotional nuances across different contexts, which is not feasible in manual workflows.

The server computes base importance values for each text unit using the importance scoring module. The server combines TF-IDF scores, keyword ranks, topic information, and role information (for example, whether a text unit is labeled as a decision, an action item, or a problem description) using a weighted formula or a small regression model, such as a linear model or a shallow neural network. The server writes the base importance values into an index table keyed by text unit identifiers. This dedicated importance index allows the server to perform fast range queries and sorts when selecting candidate units for further processing.

The server adjusts the base importance values based on emotion information to generate final importance scores. The server uses a non-linear adjustment function that increases or decreases importance depending on emotion category and intensity. For example, the server may multiply the base importance by a factor greater than one for text units with strong anxiety or anger when focusing on risk detection, or by a different factor for text units with strong joy or excitement when focusing on success summaries. The adjustment function is parameterized and can be tuned using validation data to optimize downstream summary quality. The server stores the final importance scores in the same index table, allowing subsequent modules to retrieve and use them efficiently.

The server constructs input text for a generative AI model using the generative AI interface module. The server selects a subset of text units or document units with importance scores above a threshold, and concatenates them according to chronological order and source identifiers while respecting model input length constraints measured in tokens. The server then generates a prompt sentence that encodes the type of task to be performed. For example, the server may generate the following prompt sentence for a meeting summary task:
“The following is a conversation from a project meeting. Please summarize the key decisions, action items, and deadlines in English.”

For a risk analysis task, the server may generate:
“Please analyze the following text, output a sentiment summary, and highlight any potential risks or concerns mentioned.”

For a theme-based news summary, the server may generate:
“Please summarize the following recent technology news articles, focusing on the most important innovations and their potential impact.”

The server constructs an input text by concatenating the prompt sentence and the selected text units, separated by explicit delimiters. The server encodes this input text into token sequences and transmits the tokens to the generative AI model over a model interface.

In one embodiment, the generative AI model is a transformer-based language model deployed as a remote inference service. The model includes multiple layers of self-attention, feed-forward sub-layers, positional encodings, and layer normalizations. The model has been trained using a large corpus by minimizing a predictive loss such as cross-entropy between predicted tokens and reference tokens, with weight updates performed via gradient descent. During operation in the system, the model parameters remain fixed; the server only controls the model behavior via the input tokens, prompt sentences, and decoding parameters such as maximum output length, sampling temperature, and nucleus sampling probability. By carefully crafting prompt sentences and by selecting high-importance text units as inputs, the server reduces the token count sent to the model and constrains the model's focus, thereby reducing computation time and improving the fidelity of the generated summaries relative to naive full-context summarization.

The server receives the output tokens from the generative AI model and decodes them into a summary text or an analysis-result text. The server then passes the text to the document formatting module. The server parses the generated text, detects enumerations and key phrases, and reconstructs a document format that includes headings, list expressions, and references to metadata. The server may, for example, create sections titled “Decisions,” “Action Items,” and “Risks,” and arrange bullet lists under each section based on the presence of corresponding keywords or labels in the generated text. The server associates the emotion information and importance scores of the underlying text units with the resulting document structure and stores these associations in a metadata table.

The server registers the formatted document in a data management platform or data sharing platform using the storage and access-control module. The server serializes the document format, for example as a text file with embedded markup and an accompanying metadata record, and uploads it via an application programming interface provided by the platform. The server sets access rights by writing access control entries that specify which organizational units, user groups, or roles may read or modify the document. This centralized storage with fine-grained access control reduces duplication of summaries and avoids inconsistent versions across different devices.

The server ranks documents for delivery using the ranking and delivery module. The server queries the data management platform or an internal index to retrieve candidate documents relevant to a user, a project, or a topic. The server then orders the documents according to their importance scores and emotion information. For example, the server may sort accident reports with strong negative emotion states above neutral reports on a supervisory dashboard, or sort success stories with high excitement above routine logs on a celebration view. The server packages the ranked list into a structured response that includes document identifiers, titles, emotion labels, and preview snippets, and transmits this response to the terminal.

The terminal executes a client application that displays ranked documents and detailed summaries received from the server. The terminal renders the document format into a user interface, showing headings, list expressions, and emotion indicators. The terminal allows the user to select a theme or to issue specific commands that include mentions or keywords. For example, the user may type “@bot summarize this thread” in a communication environment, or “@machine today's troubleshooting was successful” in a manufacturing context. The terminal detects these expressions locally by monitoring message events, identifies them as triggers based on configured patterns, and transmits the relevant dialogue range and trigger information to the server.

The user interacts with the system by browsing summaries, accessing full conversations or source documents through links in the terminal interface, and issuing new requests for summarization or analysis. The user may rely on emotion-aware rankings to quickly identify high-priority issues, such as threads with abnormal spikes in negative emotion, and may also review positive outcomes prioritized by strong excitement scores. In a manufacturing example, when the user sends “@machine today's troubleshooting was successful,” the terminal forwards the context to the server, the server generates a concise record summarizing the troubleshooting steps and outcomes, and the server uploads this record to a shared platform. Subsequent users can search and retrieve this record efficiently, thereby improving incident resolution speed.

The server detects abnormal emotion changes by aggregating emotion information over time.

The server maintains time-series records of emotion scores per user, per topic, or per conversation. The server computes rolling averages, standard deviations, and thresholds. When the server identifies a deviation exceeding a predetermined threshold, the server treats it as an abnormal emotion change. The server then constructs a specific prompt sentence that instructs the generative AI model to perform risk-information extraction from the associated dialogue range. For example, the server may generate:
“Analyze the following conversation, summarize the main concerns, and identify any potential operational or security risks.”

The server feeds the relevant text units and this prompt sentence into the generative AI model, obtains a risk-focused analysis-result text, and generates a warning document that is delivered to an administrator terminal. This automated, parameterized detection and analysis pipeline allows the server to identify and surface critical situations faster than manual monitoring.

The server achieves technical improvements in several ways. By converting raw text into structured text data and maintaining explicit indexes for importance and emotion, the server reduces the complexity of later selection and ranking operations, leading to lower computational overhead and faster response times. By selecting only high-importance text units and by generating task-specific prompt sentences, the server reduces the length of inputs to the generative AI model, which in turn reduces inference time and network transmission overhead. By storing emotion information and importance scores as part of the metadata, the server enables emotion-aware ranking algorithms that use cheap numerical operations instead of repeated full-text analysis. These architectural choices reduce server load, improve throughput, and decrease latency for users.

The server further improves accuracy by combining traditional natural language processing features with learned emotion features in a non-linear importance scoring function. This combination allows the server to prioritize text units that are both content-relevant and emotionally salient, which leads to summaries and alerts that better match human expectations. The server's use of transformer-based embeddings and multi-layer classifiers provides robustness across different domains and expression styles, reducing errors compared to rule-based sentiment or keyword-only methods. Because the system uses trained neural networks with specific architectures, loss functions, and optimization methods, the internal decision boundaries are derived from large-scale statistical patterns rather than simple hand-written heuristics, representing a technical advance in text processing.

In alternative embodiments, the server may use different model architectures. For example, the server may replace the multi-layer perceptron for emotion classification with a recurrent neural network or a transformer encoder fine-tuned for emotion recognition. The server may deploy the generative AI model locally on a graphics processing unit cluster instead of using a remote service, and may adjust decoding algorithms (for example, beam search width or constrained decoding rules) to trade off between speed and diversity. The server may also implement alternative importance scoring strategies, such as learning the adjustment function from labeled training data via gradient boosting or reinforcement learning, rather than defining it manually. These variants still conform to the overall structure of selecting high-importance text units, constructing prompt sentences, invoking a generative AI model, and integrating emotion-aware scores into document ranking and delivery.

In another embodiment, the terminal may perform part of the preprocessing or emotion estimation locally to reduce upstream network traffic. In such a case, the terminal sends compact representations, such as token indices and local emotion scores, to the server instead of raw text. The server then merges local features with global models, further reducing communication bandwidth and improving system scalability. In still another embodiment, multiple servers may cooperate in a distributed architecture, where one server specializes in acquisition and preprocessing, another in model inference, and another in storage and ranking. The servers exchange structured data via message queues, and each server uses dedicated hardware accelerators optimized for its tasks.

By focusing on specific data structures, algorithmic flows, and hardware-software cooperation, the system goes beyond mere automation of human reading and summarization. The server uses particular internal representations, trained models, and non-conventional processing sequences to improve computation speed, accuracy of emotion-aware importance evaluation, and efficiency of data management and communication, thereby providing a concrete improvement in computer technology.

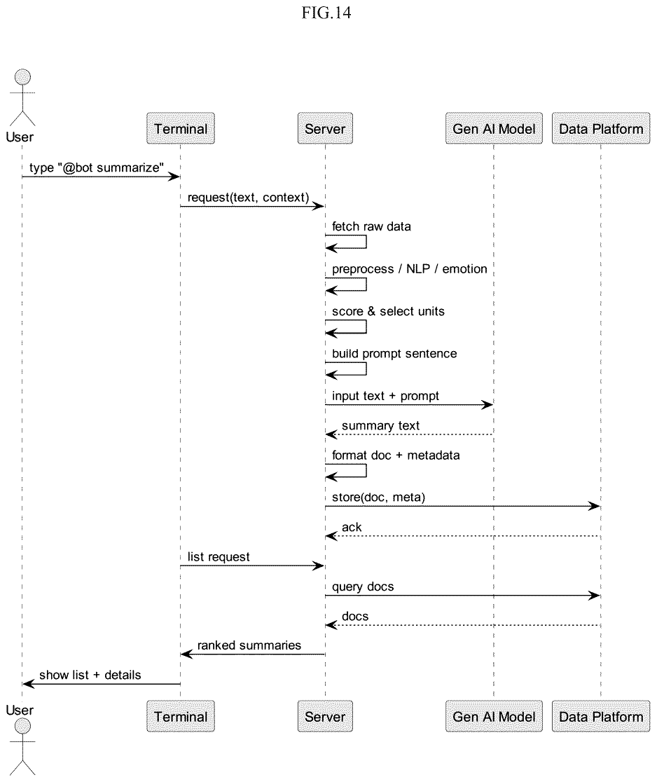

The following describes the processing flow using FIG. 14.

### Step 1:

The user initiates a task in a communication environment or information exchange environment.
The user inputs text such as a message, comment, or command (for example, “@bot summarize this thread” or “@machine today's troubleshooting was successful”) into an application running on the terminal.
Input: raw user text and contextual information (for example, conversation ID, channel ID).
Output: a displayed message in the communication environment and an event that can be detected by the terminal.
The user thereby provides trigger candidates and thematic information that the system will later process.

### Step 2:

The terminal detects trigger expressions and collects local context.
The terminal monitors incoming and outgoing messages via an application programming interface of the communication environment.
The terminal parses each message to detect specific expressions or mentions (for example, “@bot”, “@machine”, or defined keywords such as “summarize”).
Input: message events from the communication environment, including text, sender ID, channel ID, and timestamp.
Output: a trigger object including the trigger text, the surrounding message identifiers, and metadata (user ID, channel ID, time).
The terminal thereby determines that additional processing by the server should be invoked for specific conversations or topics.

### Step 3:

The terminal constructs and sends a processing request to the server.
The terminal packages the trigger object into a structured request payload and may attach an initial conversation window (for example, the last N messages in the same thread).
The terminal uses a network communication library to send an authenticated HTTPS request to the server endpoint.
Input: trigger object, optional local conversation snapshot, user authentication data.
Output: a network request transmitted to the server containing text data and control parameters (for example, requested task type: “summary”, “risk analysis”, “theme-based news”).
The terminal thus delegates heavy processing to the server while preserving sufficient context for accurate analysis.

### Step 4:

The server receives the request and retrieves full conversation or document data.
The server validates the request, checks authentication, and logs a record in a request log table.
The server uses the conversation identifiers and time information contained in the request to query external communication APIs or document repositories and to retrieve the complete dialogue range or document set relevant to the trigger.
Input: request payload (trigger text, conversation or document identifiers, time range).
Output: a collection of raw text records, each including a text body, source identifier, user identifier, and timestamp.
The server thereby aggregates all necessary raw data that will be transformed into structured text for analysis.

### Step 5:

The server preprocesses the raw text into structured text data.
The server normalizes character encoding (for example to UTF-8), removes markup and control characters, and splits the raw text into sentences and tokens.
The server applies lemmatization and part-of-speech tagging using a natural language processing library and assigns internal identifiers to each text unit (for example, each sentence or utterance segment).
Input: raw text records and associated metadata.
Output: structured text objects containing token lists, part-of-speech tags, sentence boundaries, and links to the original records.
The server thus converts unstructured strings into data structures suitable for efficient feature computation and indexing.

### Step 6:

The server computes linguistic features and basic content labels.
The server calculates term frequency-inverse document frequency values for tokens, runs a keyword extraction algorithm (for example, a graph-based ranker) on each structured text object, and may compute vector embeddings using an encoder network.
The server also assigns topic labels or role labels (for example, “problem description”, “decision”, “action item”) to text units using a trained classifier.
Input: structured text objects.
Output: feature-enriched text objects that include TF-IDF scores, keyword lists, embedding vectors, and label assignments.
The server thereby enriches each text unit with quantitative and categorical features used for scoring and grouping.

### Step 7:

The server estimates emotion states for each text unit.
The server constructs a feature vector for each text unit, combining lexical counts, syntactic patterns, and embedding values.
The server inputs these feature vectors into a trained emotion classification model, such as a multi-layer neural network, to obtain probabilities for emotion categories like joy, excitement, anxiety, anger, and neutrality.
Input: feature-enriched text objects.
Output: emotion information for each text unit, including emotion category labels and intensity scores.
The server thereby quantifies user emotion at a fine granularity across the conversation or document.

### Step 8:

The server computes base importance values based on content features.
The server uses a scoring function or regression model that takes as input the TF-IDF scores, keyword ranks, topic labels, and role labels.
The server calculates a base importance value for each text unit that reflects its content relevance and structural role (for example, decisions receive higher base values than casual remarks).
Input: feature-enriched text objects without emotion adjustment.
Output: a base importance value associated with each text unit.
The server thus generates an initial ranking of text units based on content alone.

### Step 9:

The server adjusts importance values using emotion information to obtain final importance scores.
The server applies an adjustment function that modifies the base importance according to emotion category and intensity.
For example, the server multiplies the base importance by a first factor when the emotion category is highly negative and the task is risk-oriented, and by a different factor when the emotion category is highly positive and the task is achievement-oriented.
Input: base importance values and emotion information for each text unit.
Output: final importance scores that combine content relevance and emotional salience.
The server thereby prioritizes text units that are both meaningful and emotionally significant, which improves the focus of subsequent summarization.

### Step 10:

The server selects and orders high-importance text units for model input.
The server filters text units whose final importance scores exceed a threshold or belong to the top K units for a given context.
The server sorts the selected units according to criteria such as descending importance, time order, or logical sequence within the dialogue.
Input: all text units with final importance scores.
Output: an ordered subset of text units that form the candidate input for the generative AI model.
The server thus reduces the volume of text to be processed while preserving the most critical information.

### Step 11:

The server constructs a task-specific prompt sentence.
The server determines the task type from the request (for example, meeting summary, risk analysis, theme-based news summary) and generates an appropriate prompt sentence.
For example, the server may generate:
“The following is a conversation from a project meeting. Please summarize the key decisions, action items, and deadlines in English.” or:
“Please analyze the following text, output a sentiment summary, and highlight any potential risks or concerns mentioned.”
Input: task type indicator and context information.
Output: a prompt sentence string describing the requested operation.
The server thereby encodes high-level instructions that steer the generative AI model's behavior in a controlled manner.

### Step 12:

The server assembles the input text for the generative AI model.
The server concatenates the prompt sentence and the selected ordered text units, inserting delimiters or markers to separate sections if necessary.
The server ensures that the resulting concatenated text respects the token limit of the generative AI model by truncating or summarizing sub-parts if needed.
Input: prompt sentence and the ordered subset of text units.
Output: a single input text string that will be provided to the generative AI model.
The server thus prepares a compact, instruction-rich input that focuses model computation on relevant context.

### Step 13:

The server sends the input text to the generative AI model and obtains an output text.
The server encodes the input text into tokens according to the model's tokenizer and sends the token sequence to the model through a model interface or remote inference API.
The server sets decoding parameters (for example, maximum output length, temperature, sampling mode) and initiates generation.
Input: input text tokens and decoding parameters.
Output: generated tokens that are decoded into a summary text or an analysis-result text.
The server thereby leverages the generative AI model's learned language capability while controlling cost and behavior through prompt and parameter choices.

### Step 14:

The server post-processes and structures the generated text into a document format.
The server decodes the output tokens into a character string, parses the text to detect section headings, enumerations, and key phrases, and constructs a structured document representation.
The server adds explicit headings such as “Decisions”, “Action Items”, or “Risks” when they are present or implied, and formats lists as bullet or numbered items.
Input: raw generated text from the generative AI model.
Output: a document format object including headings, list expressions, body text, and placeholders for metadata.
The server thus converts a free-form generated text into a consistently structured document suitable for storage and display.

### Step 15:

The server associates metadata, including emotion and importance, with the document format and stores it.
The server attaches to the document format the aggregated emotion information and importance scores derived from the underlying text units, as well as source information, timestamps, and user identifiers.
The server then serializes the document and metadata and uploads them to a data management platform or data sharing platform using a storage API, setting access rights according to organizational policies.
Input: structured document format and associated analysis results (emotion and importance).
Output: a stored document record accessible via the data platform with defined access permissions.
The server thereby integrates analytic results into persistent knowledge artifacts that can be reused across the organization.

### Step 16:

The server ranks stored documents for a given user or request context.
The server receives a query from the terminal, such as a request for recent summaries on a specific project or topic.
The server retrieves candidate documents from the data platform and sorts them based on the associated importance scores and emotion information, optionally applying user-specific filters or weighting.
Input: query parameters from the terminal and stored document records with metadata.
Output: an ordered list of document references with associated summary information (titles, previews, emotion labels).
The server thus transforms raw document collections into prioritized result sets tailored to the current user and context.

### Step 17:

The server sends the ranking result and document data to the terminal.
The server packages the ordered list and, when requested, corresponding document contents into a response structure and returns it via the network interface.
The server may include URLs or identifiers that allow the terminal to fetch full documents or open original conversations in the communication environment.
Input: ranked list of documents and formatted document content.
Output: a network response delivered to the terminal containing ranked items and displayable content.
The server thereby delivers processed, prioritized information instead of raw text, reducing client-side processing requirements.

### Step 18:

The terminal renders the received summaries and allows user interaction.
The terminal parses the response, displays a list of summaries ordered according to the importance and emotion-aware ranking, and renders the document formats with headings and lists.
The terminal enables the user to select items, open details, follow links to original conversations or documents, and issue further commands (for example, new mentions to trigger additional processing).
Input: response data from the server.
Output: a graphical user interface showing summaries, details, and navigation controls.
The terminal thereby provides the user with an efficient interface to consume and act on high-priority information.

### Step 19:

The user reviews the presented information and optionally initiates new processing cycles.
The user reads summaries, examines detailed sections such as “Risks” or “Action Items”, and may decide to take actions in the real environment, such as updating plans or addressing detected issues.
The user can also enter new messages or commands that serve as additional triggers, causing the cycle of acquisition, analysis, summarization, and ranking to repeat.
Input: displayed summaries and interaction controls on the terminal.
Output: new user inputs (messages, commands, theme selections) that become new starting points for subsequent processing.
The user thereby closes the loop between generated insights and operational decisions, while the server and terminal continue to manage data processing and presentation according to the defined flow.
The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

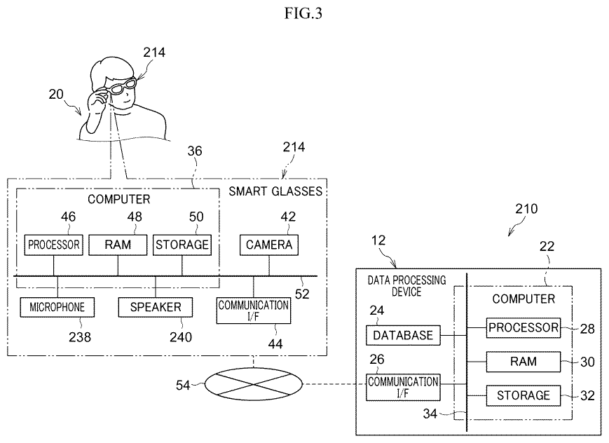

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

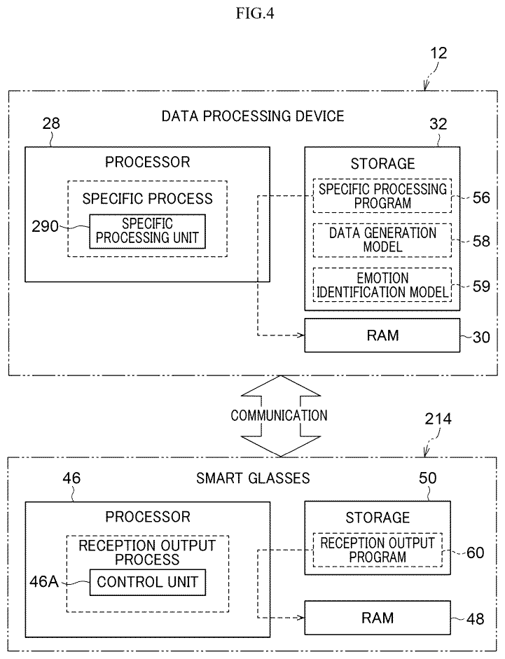

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

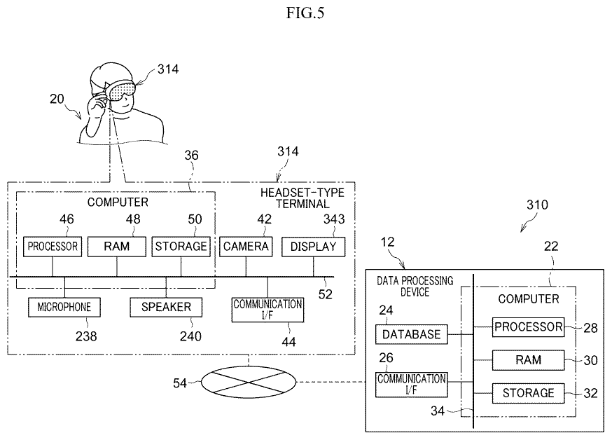

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

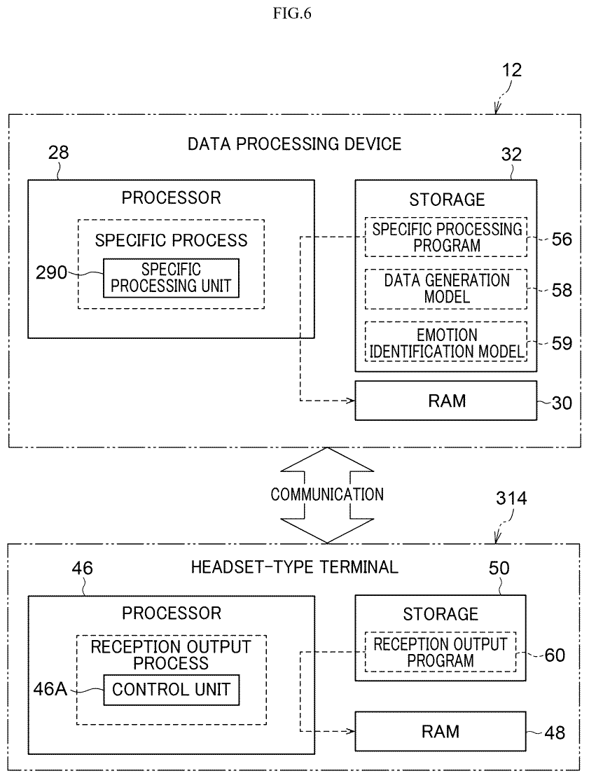

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

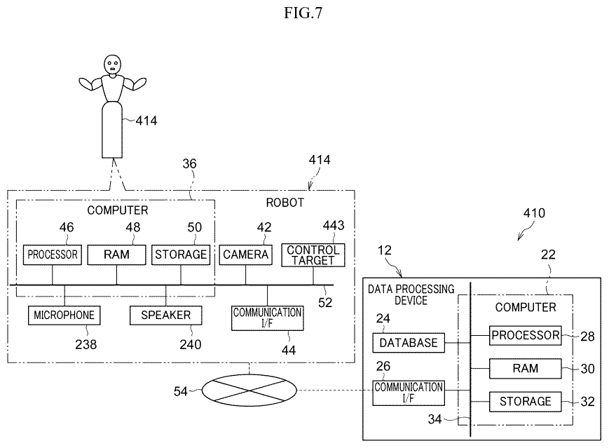

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

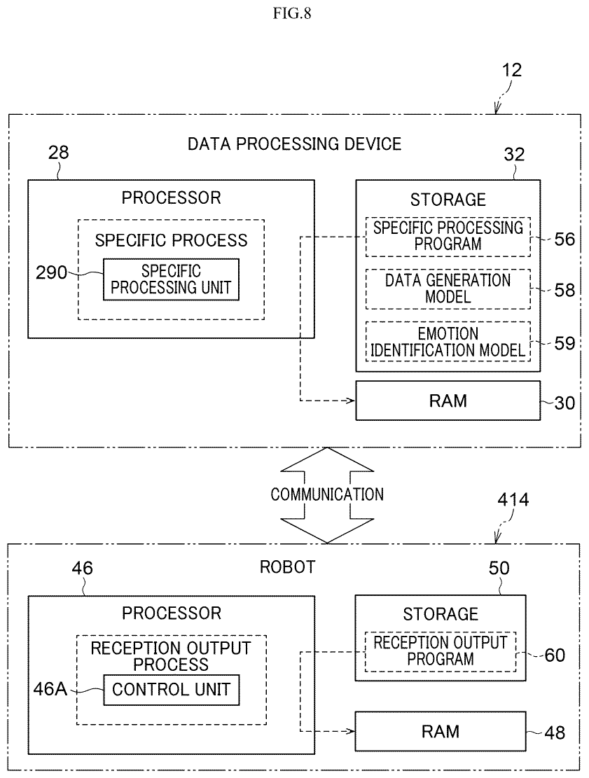

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

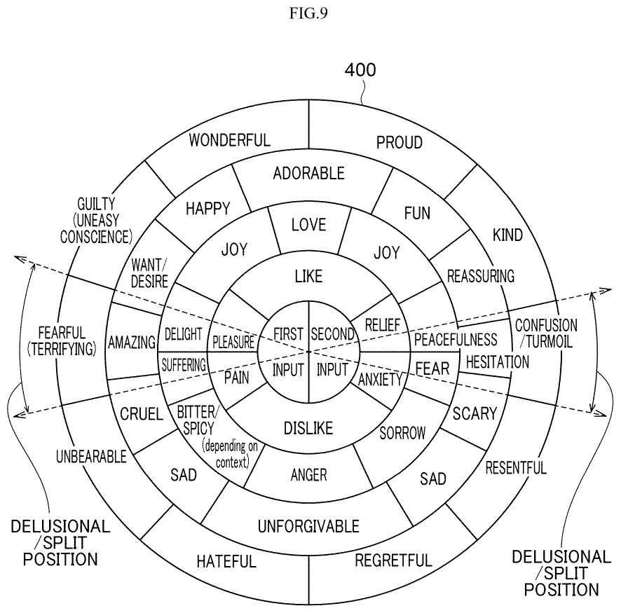

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

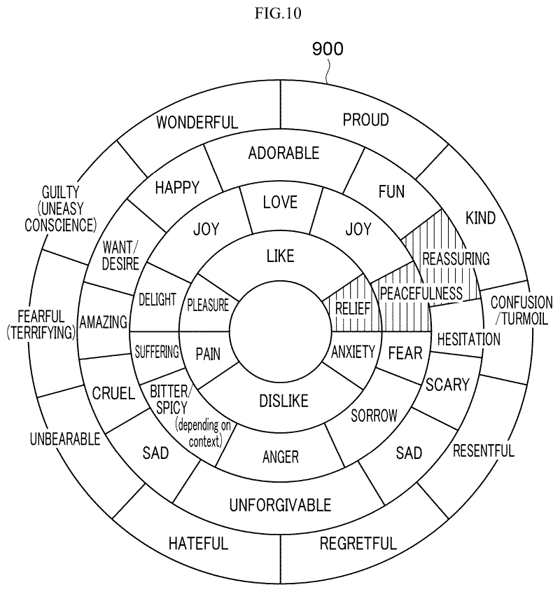

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire dialog data on an information exchange medium by collecting the dialog data from a storage unit of the information exchange medium via an external communication unit based on a predetermined condition,
preprocess the collected dialog data by using a character string processing unit and a natural language processing unit to remove unnecessary symbols and control information and to segment the dialog data into sentence units or utterance units so as to structure the dialog data as preprocessed text data,
generate input data including the preprocessed text data and a prompt sentence that defines a type of information to be extracted from the dialog data and an output format, and transmit the input data to a generative information processing model so as to instruct extraction of important information,
analyze extracted information obtained from the generative information processing model and classify the extracted information based on an information type, an importance level, and a relevance level, and integrate duplicate information or similar information to organize the extracted information as structured information,
generate summarized information in natural language that is easily understandable by a human, on the basis of the structured information, by using a summarization algorithm or the generative information processing model,
write the summarized information and the structured information into a storage unit of a data management medium by uploading the summarized information and the structured information as document data or record data via an external communication unit of the data management medium, and assign management information including identification information, period information, and user attribute information and set an access right that defines a utilization range in an organization on the basis of the management information, and
transmit the summarized information and the structured information to a terminal device and generate response data that enables the terminal device to display the summarized information and the structured information in at least one of a table format, a list format, and an indicator display format.
   (supplementary 2)

The system according to supplementary 1,
wherein the processor is configured to receive, from the terminal device, designation conditions including an analysis target period, a dialog area, and an information extraction purpose, select from a storage unit a template of the prompt sentence associated with the designation conditions, insert wording relating to the analysis target period, the dialog area, and the information extraction purpose into the template of the prompt sentence to automatically generate the prompt sentence to be transmitted to the generative information processing model, and transmit the automatically generated prompt sentence to the generative information processing model in combination with the preprocessed text data.

### (Supplementary 3)

The system according to supplementary 1,
wherein the processor is configured to, when generating the structured information, calculate a similarity between pieces of the extracted information by using a similarity calculation unit, integrate the pieces of the extracted information whose similarity is equal to or greater than a predetermined threshold as a same group, generate, on the basis of an integration result, a category-specific information set including at least one of task information, decision information, and risk information, and generate summarized information for each of the category-specific information sets.

### Application Example 1

### (Supplementary 1)

A system comprising a processor,
wherein the processor is configured to acquire, from a communication platform, conversation data generated on the communication platform, and receive, from a user terminal, the conversation data converted into structured data,
preprocess the conversation data by using a natural language processing program, the preprocessing including segmentation, normalization, and removal of unnecessary information, and extract one or more keywords from the preprocessed conversation data,
generate, from input information including the extracted keyword and at least a part of the conversation data, a prompt sentence for instructing a generative language model to identify information related to the keyword,
transmit the prompt sentence to the generative language model and obtain, from the generative language model, a search query sentence or a recommendation prompt sentence generated on the basis of the keyword and the conversation data,
execute a search request to an information storage system or an external information providing system by using the obtained search query sentence or recommendation prompt sentence, and acquire related content from the information storage system or the external information providing system,
analyze the information extracted from the conversation data and the acquired related content by using the natural language processing program and the generative language model, and organize and summarize the information on the basis of relevance and importance to generate knowledge information,
generate management data by associating the generated knowledge information and the related content with access control information, and upload the management data to a data management system so that the knowledge information and the related content are shareable within an organization, and
structure the related content and the knowledge information as recommendation information suitable for display on the user terminal, and transmit the recommendation information to the user terminal.

### (Supplementary 2)

The system according to supplementary 1,
wherein the processor is configured to
evaluate an emotional state from the conversation data by using the natural language processing program and an emotion analysis algorithm, calculate an importance level of the related content and the knowledge information on the basis of the emotional state and a user interest level estimated by the generative language model, and dynamically adjust at least one of a display order and a recommendation priority on the user terminal according to the importance level.

### (Supplementary 3)

The system according to supplementary 1,
wherein the processor is configured to
detect, in the communication platform, conversation data including at least one of a predetermined symbol, a predetermined phrase, and a predetermined action, automatically generate, in response to the detection, the prompt sentence to be transmitted to the generative language model by using the detected conversation data as a trigger, and initiate, on the basis of the prompt sentence, a series of processing including information extraction from the conversation data, keyword extraction, search query sentence generation, and related content recommendation.

### Example 2

### (Supplementary 1)

A system comprising a processor,
wherein the processor is configured to
acquire interaction data on a communication platform and character information input from an external source,
perform preprocessing including morphological segmentation, removal of non-informative terms, and normalization of word forms on the interaction data and the character information by using a document-analysis computer program, and generate internal representation data that is suitable for subsequent analysis,
execute text-mining processing including word frequency analysis, term importance calculation, topic extraction, and grouping on the internal representation data, classify information units into groups for respective topics, and generate structured information associated with the respective topics,
control a generative artificial intelligence model, on the basis of the structured information and a prompt sentence including an instruction statement input from a user, to execute summary generation processing and to generate summary information for each topic, reorganize, by using natural language processing, the summary information for each topic acquired from the generative artificial intelligence model on the basis of relevance and importance of information, and integrate the reorganized summary information as summary data in a predetermined format,
register the summary data in an information-management platform, set usage authorization on the information-management platform according to at least one of an organization unit, a user unit, and an attribute unit, and thereby make the summary data shareable across an organization, and
generate and transmit, when a dialogue including a predetermined invocation expression or symbol on the communication platform is detected, a prompt sentence that instructs the generative artificial intelligence model to treat the dialogue as a target of information-extraction processing.

### (Supplementary 2)

The System According to Supplementary 1,
wherein the processor is configured to
evaluate an emotional state for text data by using an emotion-analysis computer program, weight importance of information units included in the structured information and the summary data on the basis of the emotional state, and adjust at least one of a display order and a presentation priority of the summary data according to a result of the weighting.

### (Supplementary 3)

The System According to Supplementary 1,
wherein the processor is configured to
automatically generate a generation instruction sentence including constraint conditions indicating at least one of a summary length per topic, a representation style, and a target user group, on the basis of the prompt sentence including the instruction statement input from the user and the structured information for each topic, and transmit the generation instruction sentence to the generative artificial intelligence model so as to cause the generative artificial intelligence model to generate different summary information for the respective topics.

### Application Example 2

### (Supplementary 1)

A system comprising a processor,
wherein the processor is configured to
acquire, from a communication environment or an information exchange environment, dialogue data or document data, identify a plurality of related utterances or descriptions based on a source identifier and time information of the dialogue data or the document data, and perform preprocessing of the identified utterances or descriptions to generate structured text data,
perform natural language processing on the structured text data, the natural language processing including at least one of keyword extraction, topic classification, utterance-segment labeling, and emotion-state estimation, assign topic information, role information, and emotion information to each text unit, and calculate a base importance value for each text unit based on text features,
adjust the base importance value based on the emotion information to generate an importance score that is used for at least one of viewing, notification, and storage, and select at least one of text units and document units according to the importance score,
generate, using the selected text units or document units as input, an input text for a generative AI model by combining the input with a prompt sentence generated according to a task type, and cause the generative AI model to generate a summary text or an analysis-result text,
format the generated summary text or the analysis-result text into a document format including headings, list expressions, and metadata, associate the emotion information and the importance score with the document format, and register the document format in a data management platform or a data sharing platform while setting access rights so that the document format is usable within at least one of an organization and multiple organizations, and
in response to a request from a user terminal or in response to detection, in the user terminal, of a specific expression or a mention, rank a plurality of document formats registered in the data management platform or the data sharing platform based on the importance score and the emotion information, and transmit a result of the ranking to the user terminal.

### (Supplementary 2)

The system according to supplementary 1,
wherein the processor is configured to
analyze, based on the emotion information, at least one of a time-series change of a user emotion state and a topic-wise emotion tendency, detect an abnormal emotion change exceeding a predetermined threshold, in response to the abnormal emotion change generate a prompt sentence for instructing the generative AI model to perform at least one of summarization and risk-information extraction with respect to dialogue data or document data related to the abnormal emotion change, and transmit warning information including at least one of a summary and risk information to at least one of an administrator terminal and a predetermined user terminal.

### (Supplementary 3)

The system according to supplementary 1,
wherein the processor is configured to use a specific mention or keyword detected in the communication environment or the information exchange environment as a trigger, collect text data related to at least one of a dialogue range in which the trigger occurs and a designated topic, generate an input text for the generative AI model by combining the text data with a prompt sentence including a task description that requests at least one of “summarizing following dialogue contents or document contents and extracting decision matters, action matters, and concerns” and “evaluating emotion states and potential risks from following text,” and cause the generative AI model to automatically generate a summary text or an analysis-result text in response to the trigger.

What is claimed is:

1. A system comprising:
circuitry configured to:
acquire a collection of data records from an information exchange platform coupled to a packet-switched network, each data record including at least a text field, a source identifier, and a timestamp,
preprocess the collection of data records by removing non-semantic tokens and segmenting text into utterance units to generate preprocessed text data,
select, from a stored set of instruction templates, an instruction template corresponding to a designated extraction objective, and insert context parameters into the selected instruction template to generate an instruction sequence,
transmit the instruction sequence together with the preprocessed text data to a generative information processing model and obtain, from the generative information processing model, extracted information items,
compute vector representations for text associated with each of the extracted information items, calculate a similarity metric between pairs of the vector representations, and integrate extracted information items whose similarity metric exceeds a threshold into groups to generate structured information,
generate, from the structured information, a summarized output using a condensation algorithm, and
transmit the summarized output and the structured information as data packets via the packet-switched network to a data management node, and set, on the data management node, access authorization defining a utilization scope within an organizational entity.

2. The system according to claim 1, wherein the circuitry is further configured to assign each group of the structured information to at least one category selected from task information, decision information, and risk information based on lexical classification.

3. The system according to claim 2, wherein the circuitry is further configured to calculate an importance value for each group based on frequency of mention in the collection of data records and a relevance value based on similarity between a group description and a representation of the designated extraction objective.

4. The system according to claim 3, wherein the circuitry is further configured to rank the structured information according to the importance value and the relevance value, and transmit a notification data packet including ranked structured information to a requesting terminal via the packet-switched network.

5. The system according to claim 1, wherein the circuitry is further configured to evaluate an emotional state from the preprocessed text data using an emotion estimation model, weight each of the extracted information items based on the evaluated emotional state, and adjust a display order of the summarized output in accordance with the weighting.

6. The system according to claim 5, wherein the emotion estimation model maps text segments to coordinates in an emotion feature space defined by at least a valence axis and an arousal axis.

7. The system according to claim 5, wherein the circuitry is further configured to detect an abnormal emotion change exceeding a predetermined threshold across a time series of the emotional states, and in response generate an alert data packet including risk information derived from data records associated with the abnormal emotion change.

8. The system according to claim 1, wherein the circuitry is further configured to detect, within data records received via the packet-switched network, an invocation expression matching a predetermined trigger pattern, and in response initiate acquisition of a subset of data records associated with the detected invocation expression for processing by the generative information processing model.

9. The system according to claim 8, wherein the trigger pattern corresponds to a mention symbol referencing a system identifier on the information exchange platform.

10. The system according to claim 1, wherein the instruction sequence includes constraint conditions specifying at least one of a summary length, a representation style, and a target user group, and the generative information processing model generates different summarized outputs for respective designated extraction objectives based on the constraint conditions.

11. The system according to claim 1, wherein the circuitry is further configured to extract one or more keywords from the preprocessed text data, generate from the extracted keywords and at least a portion of the preprocessed text data a search query sequence, and transmit the search query sequence to an information retrieval node to acquire related content.

12. The system according to claim 11, wherein the circuitry is further configured to organize the related content and the extracted information items based on relevance and importance to generate knowledge data, and associate the knowledge data with access control parameters for storage on the data management node.

13. The system according to claim 11, wherein the circuitry is further configured to structure the related content and the knowledge data as recommendation data packets and transmit the recommendation data packets via the packet-switched network to a user terminal for display.

14. The system according to claim 1, wherein the generative information processing model comprises a transformer architecture including an embedding layer, a plurality of self-attention layers, and a decoding layer, and wherein model parameters have been trained by minimizing a cross-entropy loss between predicted token distributions and target tokens.

15. The system according to claim 1, wherein the circuitry is further configured to cache intermediate vector representations computed during the similarity metric calculation and reuse the cached vector representations for subsequent extraction objectives applied to overlapping subsets of the collection of data records.

16. The system according to claim 1, wherein the access authorization is set based on management information including identification information, period information, and user attribute information associated with the summarized output and the structured information.

17. The system according to claim 1, wherein the circuitry is further configured to format the structured information into at least one of a table format, a list format, and an indicator display format, and transmit the formatted structured information as a response data packet to a requesting terminal via the packet-switched network.

18. A system comprising:
circuitry configured to:
acquire data records from an information exchange platform coupled to a packet-switched network,
preprocess the data records to generate preprocessed text data,
generate an instruction sequence from a stored instruction template based on a designated extraction objective,
transmit the instruction sequence and the preprocessed text data to a generative information processing model and obtain extracted information items,
compute vector representations for the extracted information items and integrate extracted information items having a similarity metric exceeding a threshold into groups,
assign each group to at least one of a task category, a decision category, and a risk category,
evaluate an emotional state from the preprocessed text data using an emotion estimation model and weight each group based on the evaluated emotional state,
generate a summarized output from the groups using a condensation algorithm,
detect an invocation expression within the data records matching a predetermined trigger pattern and in response initiate processing of a subset of the data records, and
transmit the summarized output and the groups as data packets via the packet-switched network to a data management node with access authorization defining a utilization scope.

19. The system according to claim 18, wherein the circuitry is further configured to generate from extracted keywords and at least a portion of the preprocessed text data a search query sequence, transmit the search query sequence to an information retrieval node, acquire related content, and structure the related content as recommendation data packets for transmission to a user terminal.

20. A method comprising:
acquiring a collection of data records from an information exchange platform coupled to a packet-switched network, each data record including at least a text field, a source identifier, and a timestamp;
preprocessing the collection of data records by removing non-semantic tokens and segmenting text into utterance units to generate preprocessed text data;
selecting, from a stored set of instruction templates, an instruction template corresponding to a designated extraction objective, and inserting context parameters into the selected instruction template to generate an instruction sequence;
transmitting the instruction sequence together with the preprocessed text data to a generative information processing model and obtaining extracted information items;
computing vector representations for text associated with each of the extracted information items, calculating a similarity metric between pairs of the vector representations, and integrating extracted information items whose similarity metric exceeds a threshold into groups to generate structured information;
generating, from the structured information, a summarized output using a condensation algorithm; and
transmitting the summarized output and the structured information as data packets via the packet-switched network to a data management node, and setting access authorization defining a utilization scope within an organizational entity.
